(19) United States
(12) Patent Application Publication
(10) Pub. No.: US 2010/0215101 A1
(43) Pub. Date: Aug. 26, 2010

(54) METHOD AND AN APPARATUS FOR PROCESSING A VIDEO SIGNAL

(76) Inventors: Yong Joon Jeon, Seoul (KR); Byeong Moon Jeon, Seoul (KR); Seung Wook Park, Seoul (KR); Joon Young Park, Seoul (KR)

Correspondence Address: FISH & RICHARDSON P.C., P.O. BOX 1022, MINNEAPOLIS, MN, 55440-1022, US

(21) Appl. No.: 12/595,184

(22) PCT Filed: Apr. 10, 2008
(86) PCT No.: PCT/KR08/02025

§ 371 Date: May 4, 2010

Related U.S. Application Data
(60) Provisional application No. 60/907,573, filed on Apr. 9, 2007.
(60) Provisional application No. 60/907,810, filed on Apr. 18, 2007.
(60) Provisional application No. 60/924,889, filed on Jun. 4, 2007.
(60) Provisional application No. 60/976,490, filed on Oct. 1, 2007.
(60) Provisional application No. 60/979,074, filed on Oct. 11, 2007.
(60) Provisional application No. 60/984,382, filed on Nov. 1, 2007.
(60) Provisional application No. 60/987,781, filed on Nov. 14, 2007.
(60) Provisional application No. 60/987,780, filed on Nov. 14, 2007.

(51) Int. Cl. H04N 7/26; H04N 7/32

(52) U.S. Cl. 375/240.12; 375/240.16; 375/E07.104; 375/E07.243

(57) ABSTRACT

A method of processing a video signal is disclosed. The present invention includes extracting an overlapping window coefficient from a video signal bitstream, applying a window to at least one reference area within a reference picture using the overlapping window coefficient, obtaining a reference block by overlapping the window applied at least one reference area multiply, and obtaining a predictor of a current block using the reference block.

### TECHNICAL FIELD

The present invention relates to video signal processing, and more particularly, to an apparatus for processing a video signal and method thereof. Although the present invention is suitable for a wide scope of applications, it is particularly suitable for encoding or decoding video signals.

### BACKGROUND ART

Generally, compression coding means a series of signal processing techniques for transferring digitalized information via a communication circuit or storing digitalized information in a format suitable for a storage medium. Targets of compression coding include audio, video, character, etc. In particular, a technique of performing compression coding on a sequence is called video sequence compression. Video sequence is generally characterized in having spatial redundancy and temporal redundancy.

### DISCLOSURE OF THE INVENTION

### Technical Problem

However, if the spatial redundancy and the temporal redundancy are not sufficiently eliminated, a compression rate in coding a video signal is lowered. If the spatial redundancy and the temporal redundancy are excessively eliminated, it is unable to generate information required for decoding a video signal to degrade a reconstruction rate.

### Technical Solution

Accordingly, the present invention is directed to an apparatus for processing a video signal and method thereof that substantially obviate one or more of the problems due to limitations and disadvantages of the related art.

An object of the present invention is to provide an apparatus for processing a video signal and method thereof, by which motion compensation can be carried out based on overlapped blocks by adaptively applying a coefficient of window.

Another object of the present invention is to provide an apparatus for processing a video signal and method thereof, by which motion compensation can be carried out in a manner of performing warping transformation on a reference picture.

Another object of the present invention is to provide an apparatus for processing a video signal and method thereof, by which motion compensation can be carried out using a motion vector of a warping-transformed reference picture.

A further object of the present invention is to provide an apparatus for processing a video signal and method thereof, by which motion compensation can be carried out by generating ⅛ pel using an integer pel.

### ADVANTAGEOUS EFFECTS

Accordingly, the present invention provides the following effects or advantages.

First of all, the present invention obtains a reference block almost similar to a current block by adaptively applying a window, thereby raising coding efficiency by reducing a size of residual.

Secondly, if a current picture is zoomed in/out or rotated more than a reference picture, the present invention is able to considerably reduce the number of bits required for encoding a residual of the current picture using a warping-transformed reference picture.

Thirdly, the present invention uses a motion vector of a warping-transformed reference picture, thereby reducing the number of bits required for coding a motion vector of a current block and further omitting a transport of the motion vector.

Fourthly, since the present invention uses a scheme of generating ⅛ pel using an integer pel instead of using ½ pel or ¼ pel, it is able to generate ⅛ by a single interpolation step. Hence, the present invention is able to reduce complexity generated from performing several interpolation steps.

### DESCRIPTION OF DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic block diagram of a video signal encoding apparatus according to one embodiment of the present invention;

FIG. 2 is a schematic block diagram of a video signal decoding apparatus according to one embodiment of the present invention;

FIG. 3 is a diagram to explain a block-based motion compensation technique;

FIG. 4 is a diagram to explain window application to a reference picture in OBMC scheme;

FIG. 5 is a diagram to explain a case that window-applied reference areas in FIG. 4 are multiply overlapped;

FIG. 6 is a flowchart for OBMC scheme according to a first embodiment of the present invention;

FIG. 7 is a diagram of OMBC applied prediction picture according to a first embodiment of the present invention;

FIG. 8 is a flowchart for OBMC scheme according to a first embodiment of the present invention;

FIG. 9 is a graph of performance comparison between OBMC scheme and a related art scheme (BMC);

FIG. 10 is a schematic block diagram of a video signal encoding apparatus according to another embodiment of the present invention;

FIG. 11 is a schematic block diagram of a video signal decoding apparatus according to another embodiment of the present invention;

FIG. 12 is a diagram of reference and current pictures in case of zoom-in;

FIG. 13 is a diagram of a block corresponding to a specific object in the example shown in FIG. 12;

FIG. 14 is a diagram of reference and current pictures in case of rotation;

FIG. 15 is a diagram of a block corresponding to a specific background in the example shown in FIG. 14;

FIG. 16 is a diagram to explain the concept of affine transformation information;

FIG. 17 is a diagram to explain the concept of homography matrix information;

FIG. 18 is a flowchart of a process for obtaining warping information and a warped reference picture;

FIG. 19 is an exemplary diagram of reference and current pictures;

FIG. 20 is a diagram to explain the step S310 [corner (feature) finding step] among the steps shown in FIG. 18;

FIG. 21 is a diagram to explain the step S320 [corner tracking step] among the steps shown in FIG. 18;

FIG. 22 is a diagram to explain the step S330 [corner grouping step] among the steps shown in FIG. 18;

FIG. 23 is a diagram to explain the step S340 [outlier eliminating step] among the steps shown in FIG. 18;

FIG. 24 is a diagram to explain the step S360 [reference picture generating step] among the steps shown in FIG. 18;

FIG. 25 is a flowchart for a warping application deciding process;

FIG. 26 is a diagram to explain the concept of motion vector prediction;

FIG. 27 is a diagram to explain motion vector prediction using warping information;

FIG. 28 is a diagram to explain a first method for raising coding efficiency of warping information;

FIG. 29 is a diagram to explain a second method for raising coding efficiency of warping information;

FIG. 30 is a diagram to explain a third method for raising coding efficiency of warping information;

FIG. 31 is a diagram for a reference relation of a current picture;

FIG. 32 is a diagram to explain the concept of ⅛ pel;

FIG. 33 is a diagram to explain an interpolation step of ⅛ pel motion compensation method;

FIG. 34 is a diagram to explain positions of integer, ½ pel, ¼ pel and ⅛ pel in 2-dimension;

FIG. 35 is a diagram to explain a compensation method of pels corresponding to a first group in ⅛ pel motion compensation method according to an embodiment of the present invention;

FIG. 36 is a diagram to explain a compensation method of pels corresponding to a second group in ⅛ pel motion compensation method according to an embodiment of the present invention; and

FIG. 37 is a diagram to explain a compensation method of pels corresponding to a third group in ⅛ pel motion compensation method according to an embodiment of the present invention.

### BEST MODE

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of processing a video signal according to the present invention includes the steps of extracting an overlapping window coefficient from a video signal bitstream, applying a window to at least one reference area within a reference picture using the overlapping window coefficient, obtaining a reference block by overlapping the window applied at least one reference area multiply, and obtaining a predictor of a current block using the reference block.

Preferably, the overlapping window coefficient varies per one of a sequence, a frame, a slice and a block.

Preferably, the reference block corresponds to a common area in the overlapped reference areas.

To further achieve these and other advantages and in accordance with the purpose of the present invention, a method of processing a video signal includes the steps of obtaining a motion vector by performing motion estimation on a current block, finding a reference area using the motion vector, obtaining an overlapping window coefficient minimizing a prediction error by applying at least one window to the reference area to overlap with, and encoding the overlapping window coefficient.

Preferably, in the encoding step, the overlapping window coefficient is included in one of a sequence header, a slice header and a macroblock layer.

To further achieve these and other advantages and in accordance with the purpose of the present invention, a method of processing a video signal includes the steps of extracting OBMC (overlapped block motion compensation) application flag information from a video signal bitstream, obtaining a reference block of a current block according to the OBMC application flag information, and obtaining a predictor of the current block using the reference block.

Preferably, the reference block obtaining step is carried out using motion information of the current block.

Preferably, in the reference block obtaining step, if the OBMC application flag information means that OBMC scheme is applied to the current block or a current slice, the reference block is obtained according to the OBMC scheme.

To further achieve these and other advantages and in accordance with the purpose of the present invention, a method of processing a video signal includes the steps of obtaining a motion vector by performing motion estimation on a current block, calculating a first bit size according to a first motion compensation and a second bit size according to a second motion compensation for a reference area using the motion vector, and encoding one of information indicating the first motion compensation and information indicating the second motion compensation based on the first bit size and the second bit size.

Preferably, the first motion compensation corresponds to a block based motion compensation and the second motion compensation corresponds to an overlapped block based motion compensation.

To further achieve these and other advantages and in accordance with the purpose of the present invention, a method of processing a video signal includes the steps of extracting warping information and motion information from a video signal bitstream, transforming a reference picture using the warping information, and obtaining a predictor of a current block using the transformed reference picture and the motion information.

Preferably, the warping information includes at least one of affine transformation information and projective matrix information.

More preferably, the warping information includes position information of corresponding pairs existing in a current picture and the reference picture.

In this case, the position information of the corresponding pairs includes the position information of a first point and a difference value between the position information of the first point and the position information of a second point.

To further achieve these and other advantages and in accordance with the purpose of the present invention, a method of processing a video signal includes the steps of generating warping information using a current picture and a reference picture, transforming the reference picture using the warping information, obtaining a motion vector of a current block using the transformed reference picture, and encoding the warping information and the motion vector.

To further achieve these and other advantages and in accordance with the purpose of the present invention, a method of processing a video signal includes the steps of generating warping information using a current picture and a reference picture, transforming the reference picture using the warping information, calculating a first bit number consumed for encoding of a current block using the transformed reference picture, calculating a second bit number consumed for the encoding of the current block using the reference picture, and encoding warping application flag information based on the first bit number and the second bit number.

Preferably, the method further includes deciding whether to transport the warping information according to the first bit number and the second bit number.

To further achieve these and other advantages and in accordance with the purpose of the present invention, a method of processing a video signal includes the steps of extracting warping information and prediction scheme flag information from a video signal bitstream, obtaining a second point within a reference picture, to which at least one first point within a current picture is mapped, using the warping information according to the prediction scheme flag information, and predicting a motion vector of a current block using a motion vector corresponding to the second point.

Preferably, the first point is determined according to the prediction scheme flag information.

Preferably, the first point includes at least one of an upper left point, an upper right point, a lower left point and a lower right point.

Preferably, if there are at least two first points, the predicting the motion vector of the current block is performed by calculating an average value or a median value of the at least two point.

To further achieve these and other advantages and in accordance with the purpose of the present invention, a method of processing a video signal includes the steps of obtaining warping information using a current picture and a reference picture, obtaining a second point within the reference picture, to which at least one first point within the current picture is mapped, using the warping information, and encoding prediction scheme flag information based on a motion vector corresponding to the second point and a motion vector of a current block.

To further achieve these and other advantages and in accordance with the purpose of the present invention, a method of processing a video signal includes the steps of extracting warping information and warping skip mode flag information from a video signal bitstream, warping-transform a reference picture using the warping information according to the warping skip mode flag information, and obtaining a current block using a reference block co-located with a current block within the warping-transformed reference picture.

To further achieve these and other advantages and in accordance with the purpose of the present invention, a method of processing a video signal includes the steps of obtaining warping information using a current picture and a reference picture, warping-transform the reference picture using the warping information, obtaining a motion vector of a current block using the warping-transformed reference picture, and encoding warping skip flag information based on the motion vector.

To further achieve these and other advantages and in accordance with the purpose of the present invention, a method of processing a video signal includes the steps of searching for a position of a current ⅛ pel with reference to an integer pel, obtaining a coefficient using the position of the current ⅛ pel, and generating the current ⅛ pel using the coefficient and the integer pel.

Preferably, the integer pel includes three integer pels closer from the current ⅛ pel and the coefficient includes a first coefficient applied to a first integer pel, a second coefficient applied to a second integer pel, and a third coefficient applied to a third integer pel.

More preferably, relative values between the first to third coefficients are determined according to relative positions between the first to third integer pels, respectively.

More preferably, relative values between the first to third coefficients are determined according to a distance between the current ⅛ pel and the first integer pel, a distance between the current ⅛ pel and the second integer pel, and a distance between the current ⅛ pel and the third integer pel, respectively.

Preferably, the video signal is received via broadcast signal.

Preferably, the video signal is received via a digital medium.

To further achieve these and other advantages and in accordance with the purpose of the present invention, a computer-readable recording medium includes a program for executing a method of processing a video signal, the method including the steps of searching for a position of a current ⅛ pel with reference to an integer pel, obtaining a coefficient using the position of the current ⅛ pel, and generating the current ⅛ pel using the coefficient and the integer pel.

It is to be understood that both the foregoing general description and the following detailed description are exemplary and explanatory and are intended to provide further explanation of the invention as claimed.

### MODE FOR INVENTION

Reference will now be made in detail to the preferred embodiments of the present invention, examples of which are illustrated in the accompanying drawings.

In the present invention, it is understood that coding should conceptionally include both encoding and decoding.

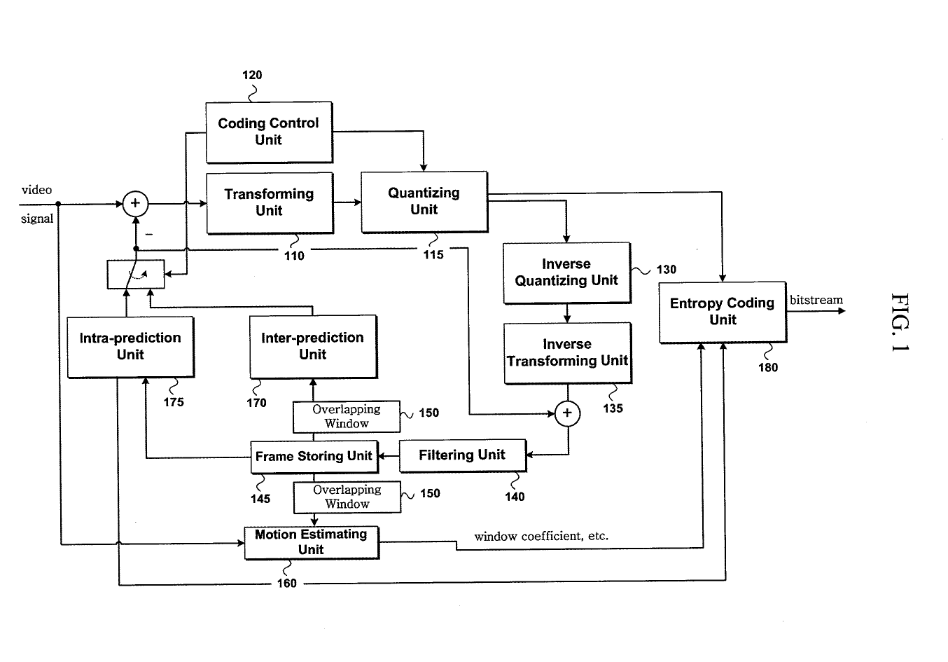

FIG. 1 is a schematic block diagram of an apparatus for encoding a video signal according to one embodiment of the present invention. Referring to FIG. 1, a video signal encoding apparatus according to one embodiment of the present invention includes a transforming unit 110, a quantizing unit 115, a coding control unit 120, an inverse quantizing unit 130, an inverse transforming unit 135, a filtering unit 140, a frame storing unit 145, a motion estimating unit 160, an inter-prediction unit 170, an intra-prediction unit 175, and an entropy coding unit 180.

The transforming unit 110 transforms a pixel value and then obtains a transformed coefficient value. For this case, DCT (discrete cosine transform) or wavelet transform is usable. The quantizing unit 115 qunatizes the transformed coefficient value outputted from the transforming unit 110. The coding control unit 120 controls whether to perform intra-picture coding or an inter-picture coding on a specific block or frame. The inverse quantizing unit 130 and the inverse transforming unit 135 inverse-quantize the transformed coefficient value and then reconstruct an original pixel value using the inverse-quantized transformed coefficient value.

The filtering unit 140 is applied to each coded macroblock to reduce block distortion. In this case, a filter smoothens edges of a block to enhance an image quality of a decoded picture. And, a selection of this filtering process depends on boundary strength and a gradient of an image sample around a boundary. Filtered pictures are outputted or stored in the frame storing unit 145 to be used as reference pictures.

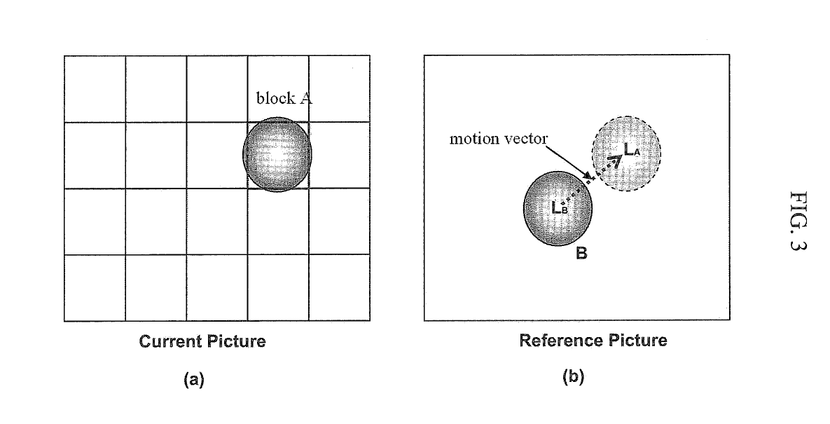

The motion estimating unit 160 searches a reference picture for a reference block most similar to a current block using the reference pictures stored in the frame storing unit 145. In this case, the reference picture is the picture having an overlapping window 150 applied thereto. In this case, a scheme for using a picture having an overlapping window applied thereto is named overlapped block motion compensation (OBMC) by overlapped block based motion estimation. Embodiment of overlapped block based motion compensation proposed by the present invention will be explained with reference to FIGS. 3 to 9 later. Meanwhile, the motion estimating unit 160 transfers a window coefficient and the like used in applying the overlapping window to the entropy coding unit 180 so that the transferred window coefficient and the like can be included in a bitstream.

The inter-prediction unit 170 performs prediction on a current picture using the reference picture to which the overlapping window 150 is applied. And, inter-picture coding information is delivered to the entropy coding unit 180. The intra-prediction unit performs intra-prediction from a decoded sample within the current picture and delivers intra-picture coding information to the entropy coding unit 180.

The entropy coding unit 180 generates a video signal bitstream by performing entropy coding on a quantized transformed coefficient value, intra-picture coding information and inter-picture coding information. In this case, the entropy coding unit 180 is able to use variable length coding (VLC) and arithmetic coding. The variable length coding (VLC) transforms inputted symbols into continuous codeword. And, a length of the codeword may be variable. For instance, frequently generated symbols are represented as a short codeword, whereas non-frequently generated symbols are represented as a long codeword. Context-based adaptive variable length coding (CAVLC) is usable as variable length coding. The arithmetic coding transforms continuous data symbols into a single prime number. And, the arithmetic coding is able t obtain an optimal prime bit required for representing each symbol. Context-based adaptive binary arithmetic code (CABAC) is usable for arithmetic coding.

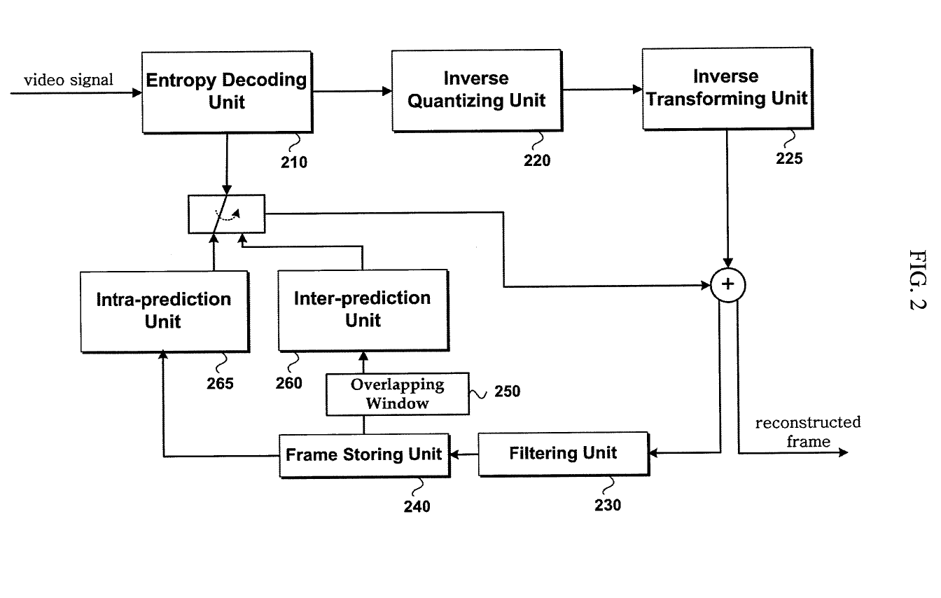

FIG. 2 is a schematic block diagram of a video signal decoding apparatus according to one embodiment of the present invention. Referring to FIG. 2, a video signal decoding apparatus according to one embodiment of the present invention includes an entropy decoding unit 210, an inverse quantizing unit 220, an inverse transforming unit 225, a filtering unit 230, a frame storing unit 240, an inter-prediction unit 260, and an intra-prediction unit 265.

The entropy decoding unit 210 entropy-decodes a video signal bitstream and then extracts a transform coefficient of each macroblock, a motion vector and the like. The inverse quantizing unit 220 inverse-quantizes an entropy-decoded transform coefficient, and the inverse transforming unit 225 reconstructs an original pixel value using the inverse-quantized transform coefficient. Meanwhile, the filtering unit 230 is applied to each coded macroblock to reduce block distortion. Filter smoothens edges of a block to enhance image quality of a decoded picture. The filtered pictures are outputted or stored in the frame storing unit 240 to be used as reference pictures.

The inter-prediction unit 260 predicts a current picture using the reference pictures stored in the frame storing unit 240. As mentioned in the foregoing description of FIG. 1, a reference picture having an overlapping window applied thereto is used. Meanwhile, the inter-prediction unit 260 is able to receive a window coefficient and the like required for applying the overlapping window 250 from the entropy decoding unit 210. This will be explained with reference to FIGS. 3 to 9 later.

The intra-prediction unit 265 performs inter-picture prediction from a decoded sample within a current picture. A predicted value outputted from the intra-prediction unit 265 or the inter-prediction unit 260 and a pixel value outputted from the inverse transforming unit 225 are added together to generate a reconstructed video frame.

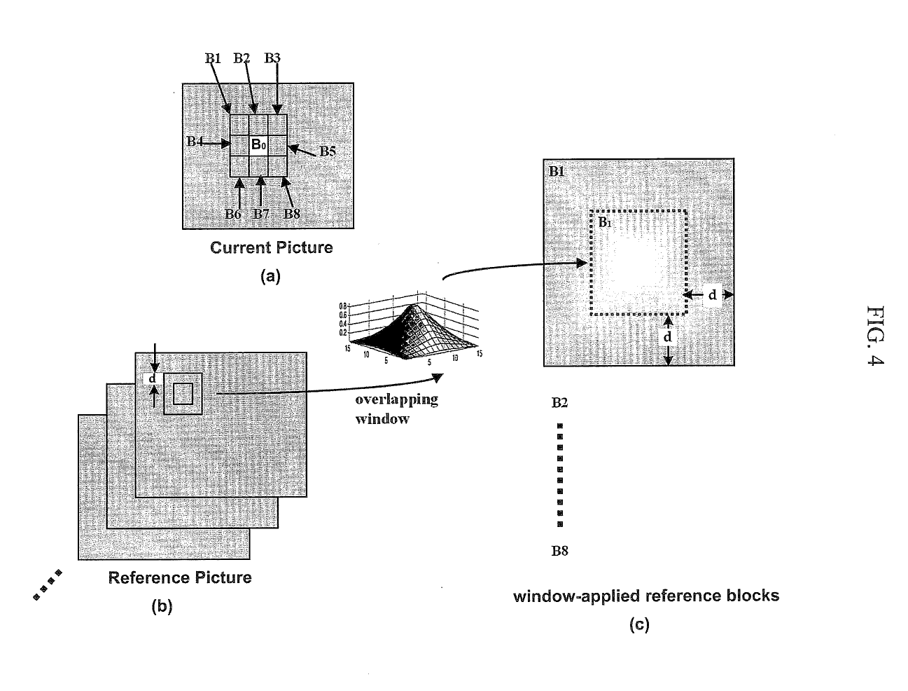

In the following description, the block-based motion compensation technique is explained with reference to FIG. 3 and overlapped block motion compensation (OBMC) according to an embodiment of the present invention is then explained with reference to FIGS. 4 to 9.

FIG. 3 is a diagram to explain a block-based motion compensation technique.

Referring to (a) of FIG. 3, a current picture is divided into a plurality of blocks in specific size. In order to estimate a motion of a current block A, a reference picture shown in (b) of FIG. 3 is searched for a reference block B that is most similar to the current block A. In this case, an offset between a co-location L_{A} of the current block A and a location L_{B} of the reference block B becomes a motion vector. Hence, a predicted value of the current block is obtained by finding the reference block B most similar to the current block using the motion vector. And, it is then able to reconstruct the current block by adding a residual signal to the predicted value.

Thus, the technique of performing the block-based motion compensation is efficient in eliminating redundancy between frames neighboring to each other but is disadvantageous in generating blocking artifact from a block boundary. The blocking artifact lowers coding efficiency and reduces image quality. To make efforts to solve this problem, overlapped block based motion compensation (OBMC) has been proposed. In the following description, first and second embodiments for the overlapped block based motion compensation (OBMC) according to the present invention are explained.

FIG. 4 is a diagram to explain window application to a reference picture in OBMC scheme according to a first embodiment of the present invention. Referring to (a) of FIG. 4, it can be observed that a current block B₀ and neighbor blocks B₁ to B₈ surrounding the current block B₀ exist.

Referring to (b) of FIG. 4, by applying an overlapping window to reference blocks B₁ to B₈, which correspond to the neighbor blocks B₁ to B₈, respectively, within a reference picture, reference blocks having the window applied thereto, as shown in (c) of FIG. 4, are generated.

In the window, a relatively heavy weight is given to a central portion and a relatively light weight is given to a peripheral portion. In this case, instead of applying the window to an area corresponding to the reference block B₁ only, the window is applied to an area including the reference block B₁ and a peripheral portion d as well. In this case, the window may be fixed. Alternatively, the window can be adaptively defined to differ for each sequence, frame, slice or macroblock. For instance, the window can be defined as s shown in Formulas 1 to 3.

$$\begin{matrix}w = {argmin}_{w} E & [ Formula 1 ] \\ E = {\sum }_{p}^{ } {[ {I}_{n} ( p ) - {\hat{I}}_{n} ( p ) ]}^{2} & [ Formula 2 ] \\ {\hat{I}}_{n} ( p ) = {\sum }_{m}^{ } w ( p - Sm ) {I}_{n - 1} ( p - v ( m ) ) & [ Formula 3 ]\end{matrix}$$

In the above formulas, ‘w’ indicates an overlapping window coefficient, ‘E’ indicates a sum of squares of predictive errors, ‘I’ indicates a pel intensity in picture, ‘p’ indicates a pixel position vector, ‘S’ indicates a block size, and ‘m’ indicates a relative location for a current block [e.g., if a current block is at (0, 0), an above block is at (−1, 0).].

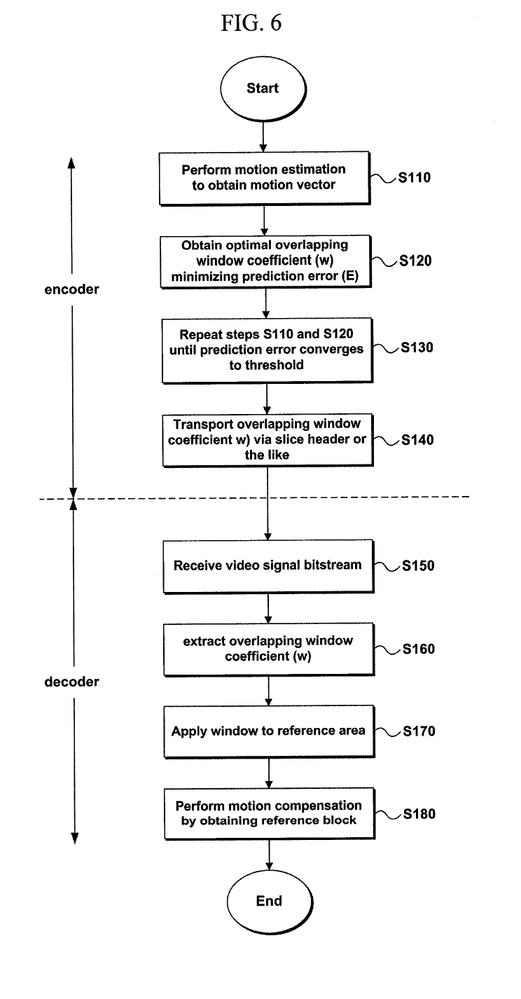

Referring to Formulas 1 to 3, the overlapping window coefficient w can be determined different according to a predictive error E. And, corresponding details shall be explained with reference to FIG. 6 later.

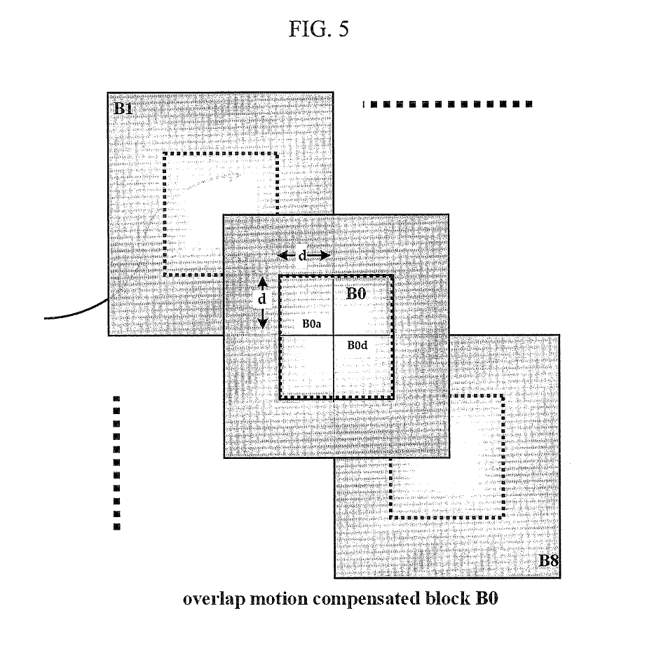

FIG. 5 is a diagram to explain a case that window-applied reference areas in FIG. 4 are multiply overlapped.

Referring to FIG. 5, it can be observed that a plurality of reference areas B₁ to B₈ having a window applied thereto are overlapped with each other. In this case, it is able to obtain a reference block B₀ corresponding to a current block from an area overlapped in common. For instance, a first reference area B₁ is overlapped with a left above area B₀ₐ of the reference block B₀ corresponding to the current block, and an eighth reference area B₈ is overlapped with a left above area B₀ₐ of the reference block B0 corresponding to the current block. Thus, if the reference block B₀ corresponding to the current block is obtained from the overlapped area, it is able to eliminate a blocking artifact on a block boundary and a most suitable predictor can be obtained. Hence, it is able to minimize a bit size of residual.

FIG. 6 is a flowchart for OBMC scheme according to a first embodiment of the present invention.

Referring to FIG. 6, steps S110 to S140 are the steps carried out by an encoder and can be carried out by the video signal encoding apparatus according to the first embodiment of the present invention described with reference to FIG. 1. Steps S150 to S180 are the steps carried out by a decoder and can be carried out by the video signal decoding apparatus according to the first embodiment of the present invention described with reference to FIG. 2.

First of all, the encoder carries out motion estimation to obtain a motion vector [S110]. The motion compensation is carried out to minimize energy of error transform coefficients after completion of quantization. And, energy within a transformed block depends on energy within an error block prior to the transformation. So, the motion estimation is to find a block/area, which matches a current block/area, minimizing energy within a motion-compensated error (i.e., difference between a current block and a reference area). In doing so, a process for evaluating error energy at many points is generally required. And, a selection for an energy measuring method affects operational complexity and accuracy in a motion estimation process. Three kinds of energy measuring methods are available.

(1) Mean Square Error

$$MSE = \frac{1}{{N}^{2}} {\sum }_{i = 0}^{N - 1} {\sum }_{j = 0}^{N - 1} {( {C}_{ij} - {R}_{ij} )}^{2}$$

In this case, ‘Cᵢⱼ’ indicates a sample of a current block and ‘Rᵢⱼ’ indicates a sample of a reference area.

(2) Mean Absolute Error

$$MAE = \frac{1}{{N}^{2}} {\sum }_{i = 0}^{N - 1} {\sum }_{j = 0}^{N - 1} \vert {C}_{ij} - {R}_{ij} {\vert}^{ }$$

(3) Sum of Absolute Error

$$SAE = {\sum }_{i = 0}^{N - 1} {\sum }_{j = 0}^{N - 1} \vert {C}_{ij} - {R}_{ij} {\vert}^{ }$$

Further, SA(T)D (the sum of absolute differences of the transformed residual data) can be used as another energy measuring method.

Meanwhile, in carrying out the motion estimation, full such scheme, fast search scheme and the like are usable. The full search scheme calculates SAE and the like at each point within a window. First of all, the full search can be performed by moving a window outwardly in a spiral direction from an initial search position at a center. The full search scheme is able to find a minimal SAE and the like but may require considerably heavy operation amount due to energy measurement at every position. The fast search scheme is to measure energy for partial positions among whole positions within a search window only and includes three step search (TSS (Three Step Search), N-step search), logarithmic search, nearest neighbors search or the like.

Optimal overlapping window coefficient w, which minimizes an overall predictive error (E), is obtained using the motion vector obtained in the step S110 [S120]. And, the overlapping window coefficient w may vary according to sequence, frame, slice or block.

Subsequently, the steps S110 and S120 are repeated using the SAD and the like shown in Formula 4 until the predictive error E converges to a threshold [S130].

$$argmin {\sum }_{p}^{ } \vert {I}_{n} ( p ) - {\sum }_{m}^{ } w ( p - Sm ) {I}_{n - 1} ( p - v ( m ) ) \vert \qquad [ Formula 4 ]$$

The encoder makes the optimal overlapping window coefficient w included in a syntax element and then transports it via a video signal bitstream [S140].

If so, the decoder receives the video signal bitstream [S150] and then extracts the overlapping window coefficient w from the received video signal bitstream [S160]. Subsequently, the decoder multiply overlaps reference areas with each other by applying a window to each of the reference areas of a reference picture using the overlapping window coefficient w [S170]. The decoder obtains a reference block from the multiply overlapped reference area and then performs motion compensation for obtaining a predictive value (predictor) of a current block using the obtained reference block [S180].

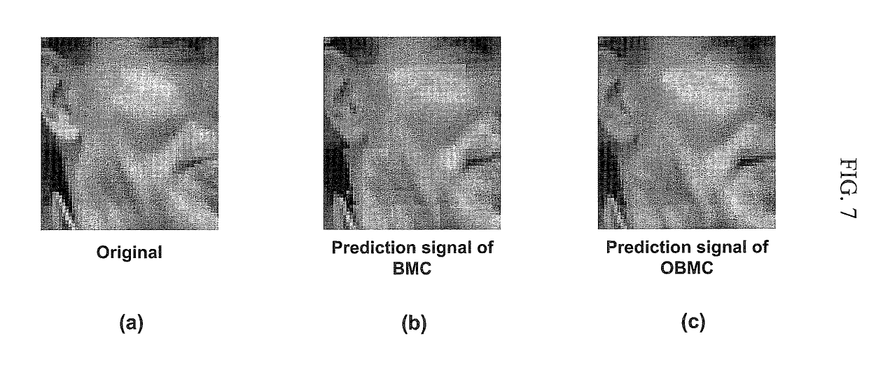

FIG. 7 is a diagram of OMBC applied prediction picture according to a first embodiment of the present invention. In FIG. 7, (a) shows an original picture, (b) shows a prediction obtained by applying motion compensation (BMC) of the related art, and (c) shows a prediction obtained by applying OBMC of the present invention. It can be observed from (c) of FIG. 7 that a block artifact is improved better than that shown in (b) of FIG. 7.

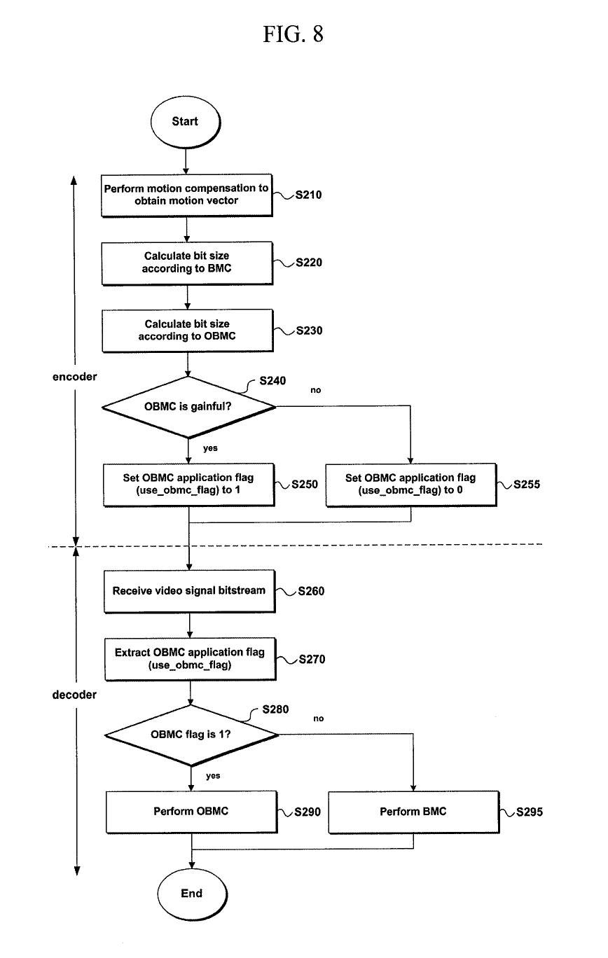

FIG. 8 is a flowchart for OBMC scheme according to a first embodiment of the present invention. Like the first embodiment of the present invention, steps S210 to S255 are carried out by an encoder and steps S260 to S295 are carried out by a decoder.

First of all, the encoder performs motion estimation to obtain a motion vector [S210]. The encoder obtains a predictor of a current slice or block by applying the related art motion compensation (BMC) and then calculates a bit size consumed for coding a residual [S220]. The encoder obtains a predictor of the current slice or block by applying overlapped block based motion compensation (OBMC) and then calculates a bit size consumed for coding a residual [S230].

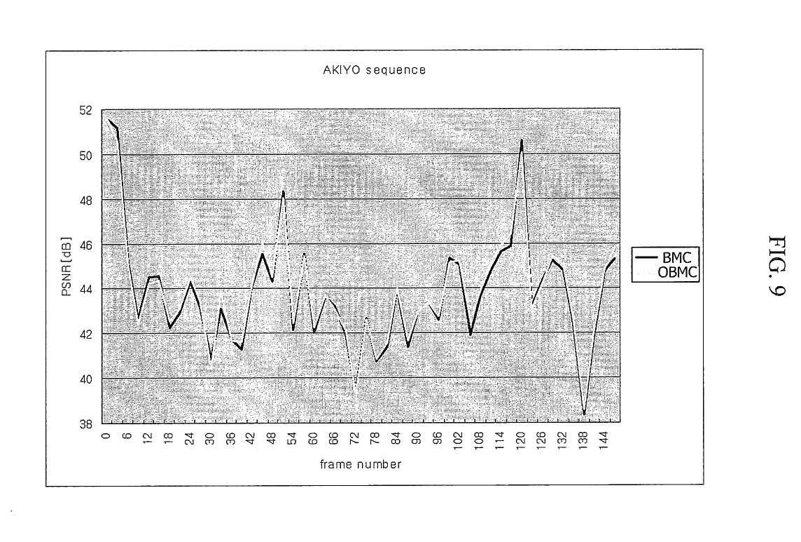

Subsequently, by comparing a result of the step S220 and a result of the step S230 to each other, the encoder decides whether the OBMC is gainful in aspect of the bit size [S240]. FIG. 9 is a graph of performance comparison between OBMC scheme and a related art scheme (BMC). Referring to FIG. 9, OBMC is dominant in aspect of coding efficiency overall. It can be also observed that BMC is partially dominant. For instance, it can be observed that BMC is efficient in areas of frames number 12 to 18 and 112 to 118. Thus, since BMC may be partially advantageous, it is decided which scheme is advantageous per frame, slice or block.

Referring now to FIG. 8, as a result of the decision made by the step S240, if OBMC is advantageous (‘yes’ in the step S240), an identifier indicating that OBMC is applied is set [S250]. For instance, it is able to set OBMC application flag information to 1. Otherwise, if BMC is advantageous, an identifier indicating that BMC is applied is set [S255]. For instance, OBMC application flag information is set to 0. Table 1 and Table 2 indicate OBMC application flag information and its meaning.

TABLE 1
Meaning of OBMC application flag
information

| use_obmc_flag | Meaning |
|---|---|
| 0 | OBMC is not applied to a current slice |
| | or a current frame. |
| 1 | OBMC is not applied to a current slice |
| | or a current frame. |

TABLE 2

| | Meaning |
|---|---|
| 0 | OBMC is not applied to a current |
| | block. |
| 1 | OBMC is applied to a current block. |

Referring to Table 1, in case that OBMC application flag information is the information indicating that OBMC is applied to a current slice or a current frame, an OBMC application flag can be contained in a slice header, a sequence header or the like.

Referring to Table 2, in case that OBMC application flag information is the information on a current block, the OBMC application flag information can be contained in a macroblock layer, which does not put limitations on the present invention.

2. Warping Transform

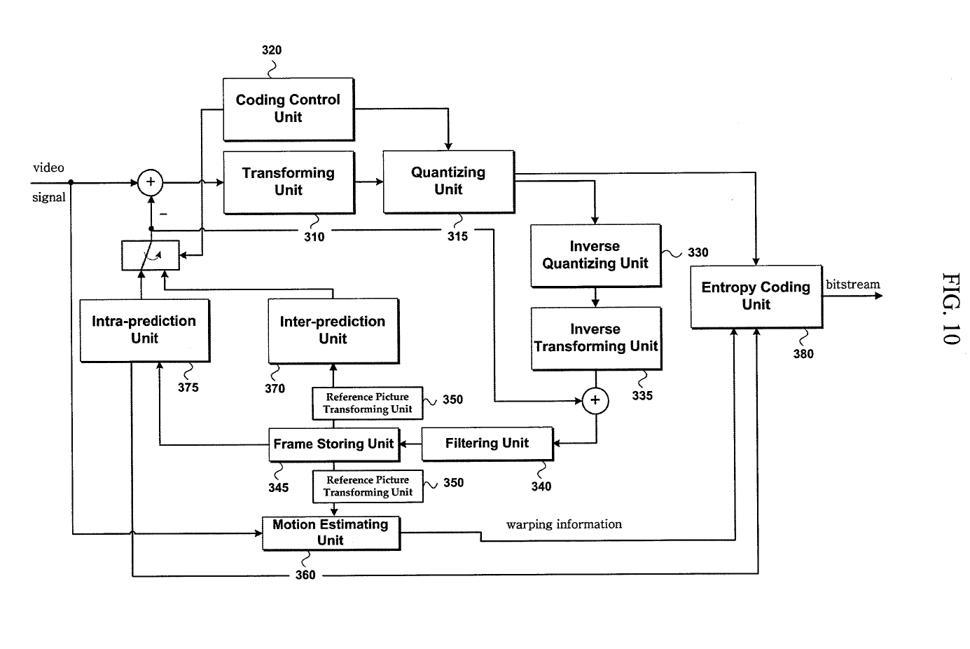

FIG. 10 is a schematic block diagram of a video signal encoding apparatus according to another embodiment of the present invention.

Referring to FIG. 10, a video signal encoding apparatus according to another embodiment of the present invention includes a transforming unit 310, a quantizing unit 315, a coding control unit 320, an inverse quantizing unit 330, an inverse transforming unit 335, a filtering unit 340, a frame storing unit 345, a reference picture transforming unit 350, a motion estimation unit 360, an inter-prediction unit 370, an intra-prediction unit 375, and an entropy coding unit 380. The elements except the reference picture transforming unit 350 and the motion estimation unit 360 perform functions almost similar to those of the elements having the same names in the elements of the former encoding apparatus described with reference to FIG. 1. So, their details are omitted in the following description.

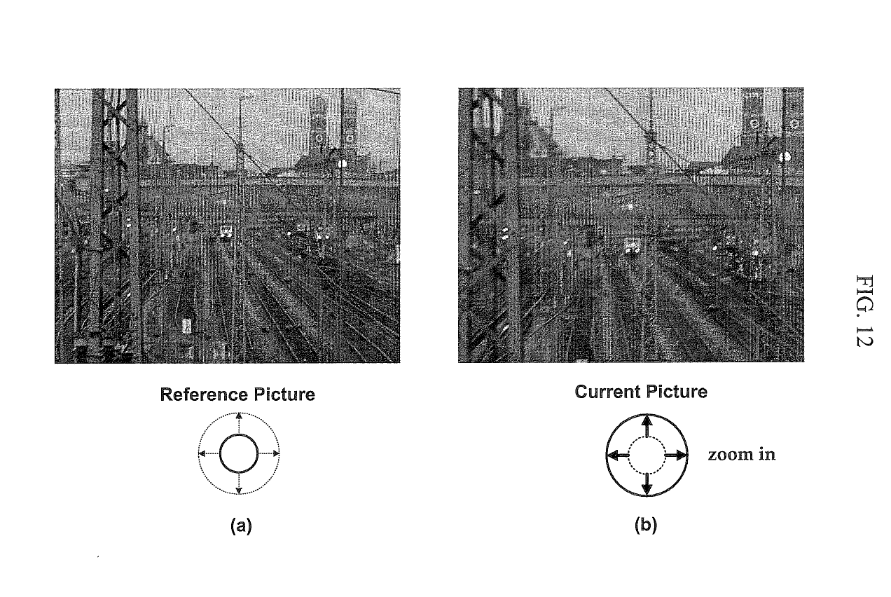

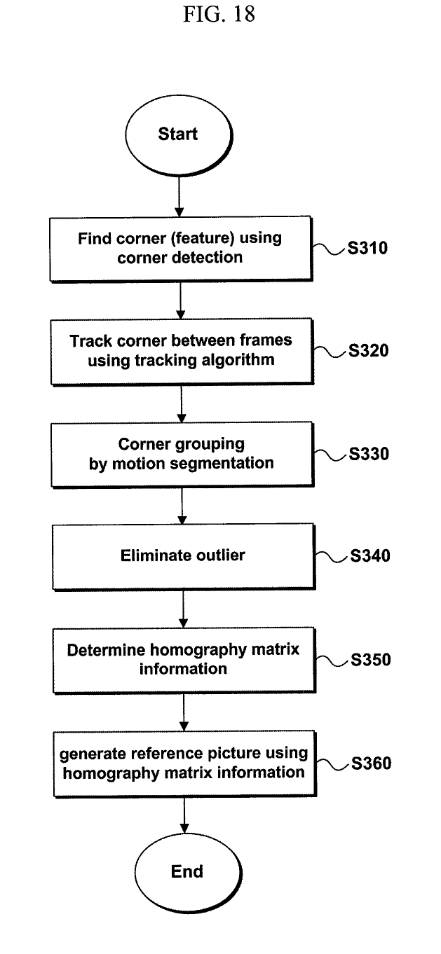

Meanwhile, the reference picture transforming unit 350 obtains warping information using a reference picture and a current picture and then generates a transformed reference picture by warping the reference picture according to the obtained warping information. And, the warping information is transferred to the entropy coding unit 380 via the motion estimation unit 360 and then contained in a bitstream. The concepts and types of the warping information shall be explained with reference to FIGS. 12 to 17 and a warping information obtaining method and a warped reference picture obtaining method shall be explained with reference to FIGS. 18 to 24.

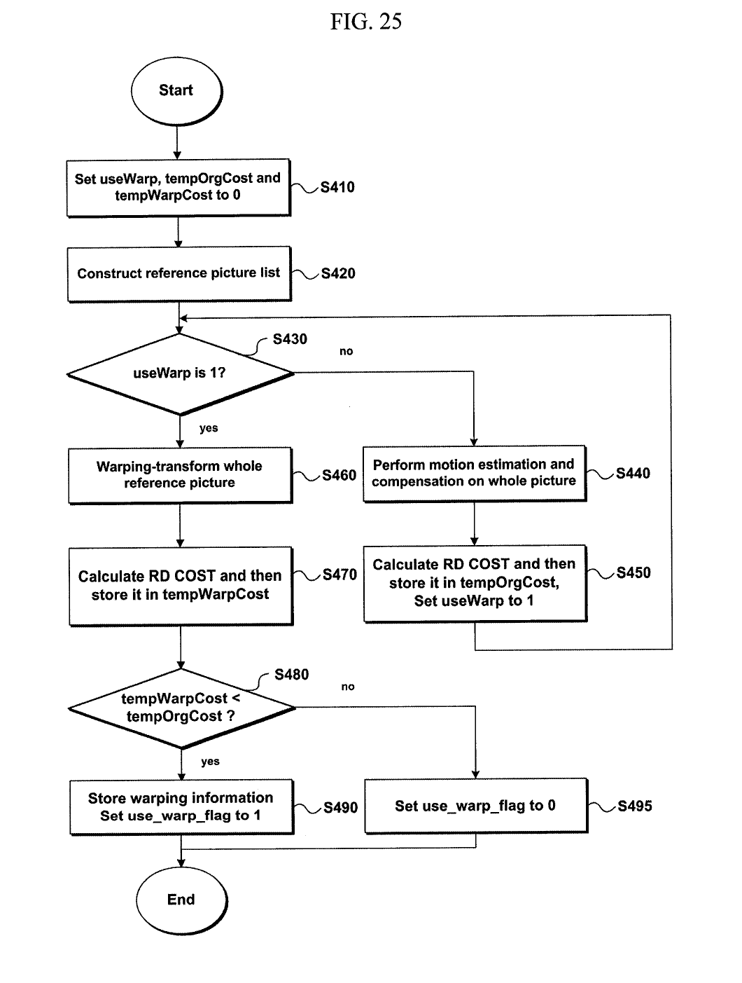

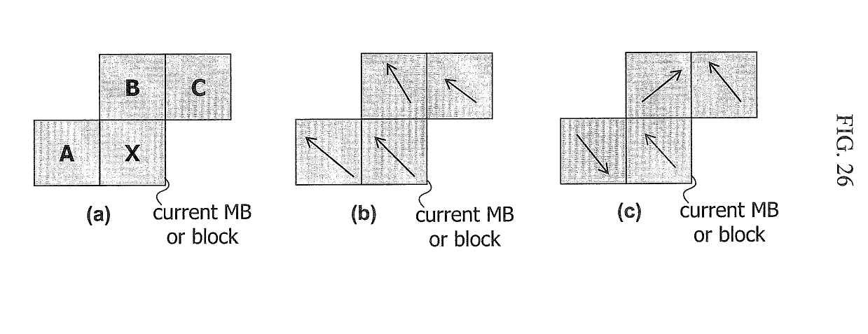

The motion estimation unit 360 estimates a motion of the current block using the warped reference picture and/or an original reference picture. 1) A setting process for deciding whether to use the original reference picture or the warped reference picture will be explained with reference to FIG. 25, 2) A method of predicting a current motion vector using warping information will be explained with reference to FIG. 26, 3) A method of efficiently transporting warping information will be explained with reference to FIGS. 28 to 30, and 4) whether to skip a transport of a motion vector or the like because of transporting warping information will be explained later.

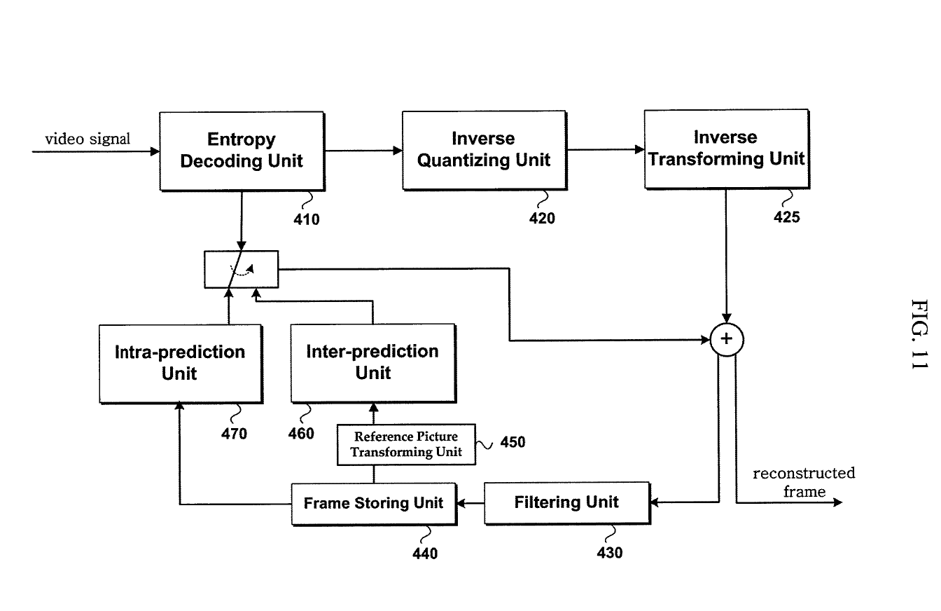

FIG. 11 is a schematic block diagram of a video signal decoding apparatus according to another embodiment of the present invention.

Referring to FIG. 11, a video signal decoding apparatus according to another embodiment of the present invention includes an entropy decoding unit 410, an inverse quantizing unit 420, an inverse transforming unit 425, a filtering unit 430, a frame storing unit 440, a reference picture transforming unit 450, an inter-prediction unit 460, and an intra-prediction unit 470. The elements except the reference picture transforming unit 450 and the inter-prediction unit 460 perform functions almost similar to those of the elements having the same names in the elements of the former video signal decoding apparatus described with reference to FIG. 2. So, their details are omitted in the following description.

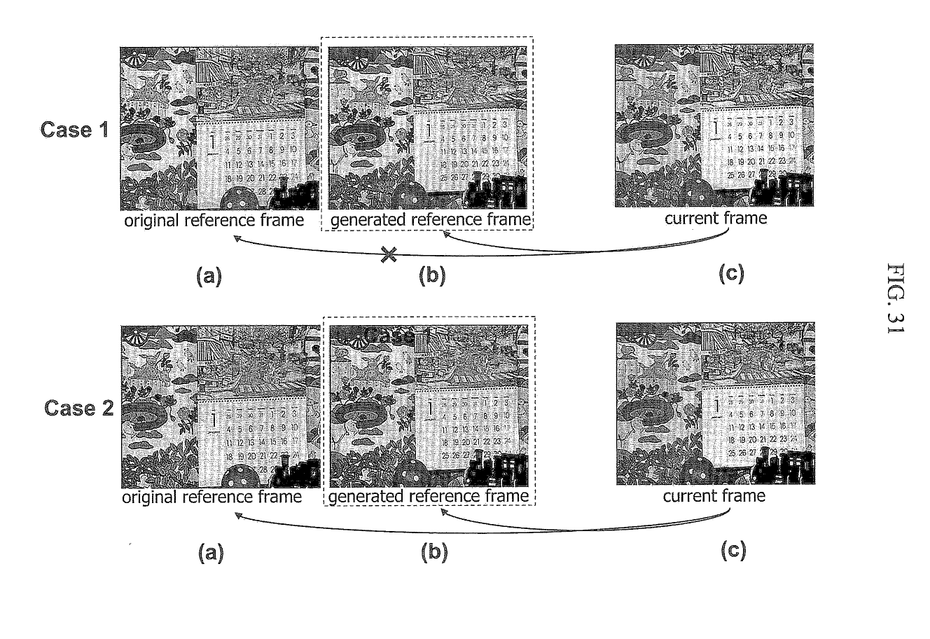

The reference picture transforming unit 450 warping-transforms a reference picture stored in the frame storing unit 440 using the warping information extracted from the video signal bitstream. Its details will be explained with reference to FIG. 31 later. Meanwhile, the inter-prediction unit 460 generates a prediction of a motion vector using the warping information and then obtains a motion vector using the prediction of the motion vector and a residual of the motion vector. Its details will be explained later.

In the following description, warping information concept and a process for obtaining warping information in an encoder, a warping information transporting method, and a method of using warping information in a decoder are explained in order.

2.1 Warping Information Obtainment (in Encoder)

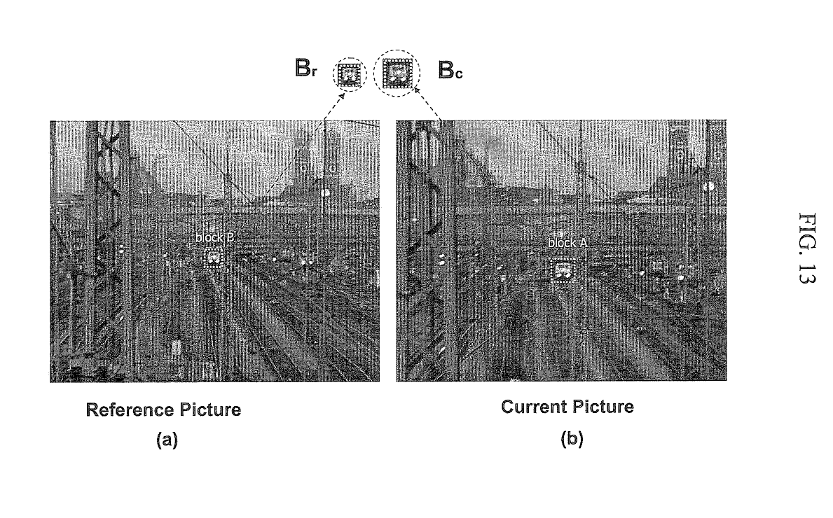

FIG. 12 is a diagram of reference and current pictures in case of zoom-in, and FIG. 13 is a diagram of a block corresponding to a specific object in the example shown in FIG. 12.

Referring to FIG. 12, (a) shows a reference picture and (b) shows a current picture. Comparing the reference picture and the current picture to each other, a background (poles) and an object (train) are zoomed-in in the current picture.

Referring to FIG. 13, it is able to compare the object (train) in the reference picture of (a) to the object in the current picture of (b). Thus, in case of zoom-in, when a reference block having the same size of a current block B_{C} is searched for, it may fail to search for a most similar reference block or a residual corresponding to a difference between the current block and the reference block is increased. Hence, coding efficiency may be lowered.

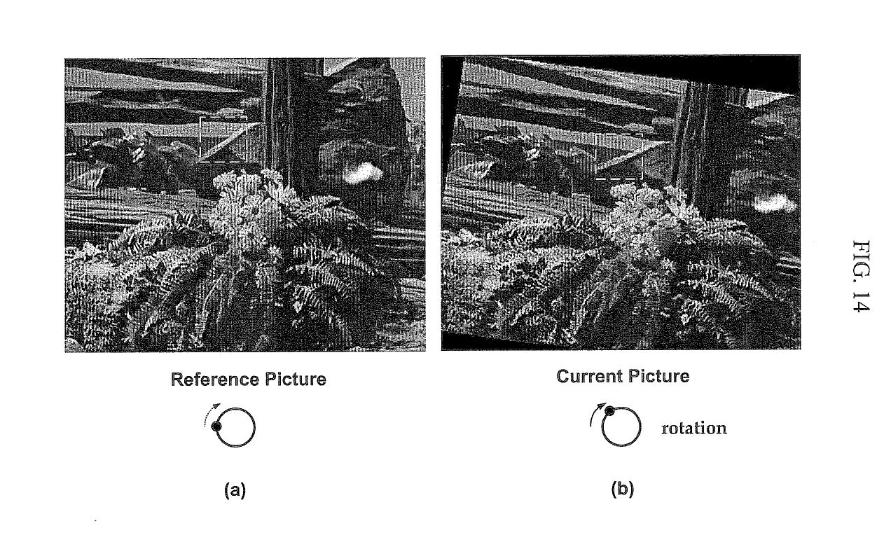

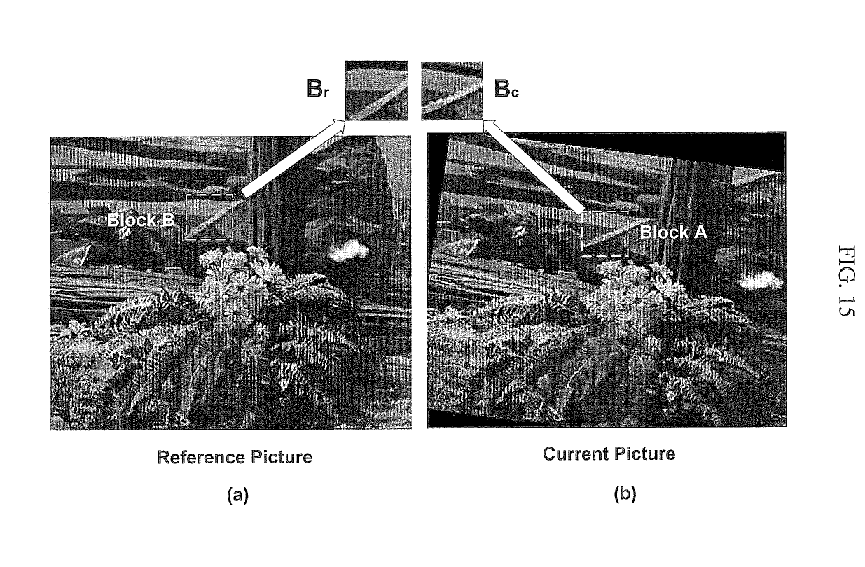

FIG. 14 is a diagram of reference and current pictures in case of rotation, and FIG. 15 is a diagram of a block corresponding to a specific background in the example shown in FIG. 14.

Referring to FIG. 14, (a) shows a reference picture and (b) shows a current picture. The current picture results from rotating the reference picture clockwise.

Referring to FIG. 15, it is able to compare a specific background (rock surface) in the reference picture to a specific background in the current picture. In measuring energy for motion estimation, error between the same positions within the reference blocks and the current blocks is calculated. Like the case of zoom-in, it may fail to search for a most similar reference block or coding efficiency of a residual may be considerably lowered.

(1) Types of Warping Information

As mentioned in the foregoing description, if a reference picture is zoomed in/out or rotated, it is able to use warping information to zoom in/out or rotate the reference picture to become similar to a current picture overall. Warping information may include affine transformation information, projective transformation information, and the like.

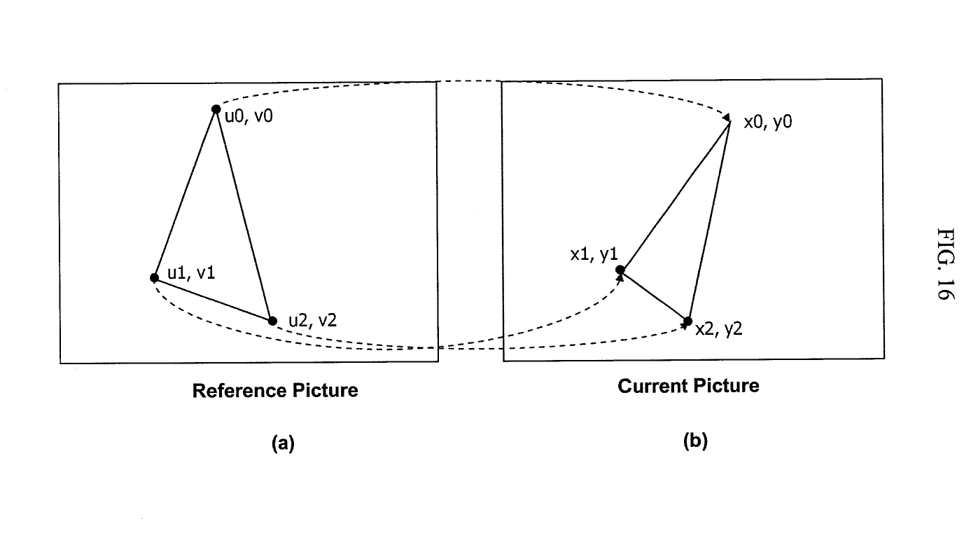

FIG. 16 is a diagram to explain the concept of affine transformation information.

Referring to FIG. 16, it can be observed that three points [(u₀, v₀), . . . , (u₂, v₂)] exist in a reference picture (a) and it can be also observed that three points [(x₀, y₀), . . . , (x₂, y₂) respectively corresponding to the former points [(u₀, v₀), . . . , (u₂, v₂)] exist in a current picture (b). And, affine transformation information can be defined as follows using total six control points including three control points of a reference picture and three control points of a current picture.

$$[ \begin{matrix}x 0 & y 0 & 1 \\ x 1 & y 1 & 1 \\ x 2 & y 2 & 1\end{matrix} ] = [ \begin{matrix}u 0 & v 0 & 1 \\ u 1 & v 1 & 1 \\ u 2 & v 2 & 1\end{matrix} ] [ \begin{matrix}a 11 & a 12 & 0 \\ a 21 & a 22 & 0 \\ a 31 & a 32 & 1\end{matrix} ] \qquad [ Formula 5 ]$$

In Formula 5, ‘aᵢⱼ’ indicates an element of affine transformation information, (uₘ, yₘ) indicates a position of a point in a reference picture, and (xₙ, yₙ) indicates a position of a point in a current picture.

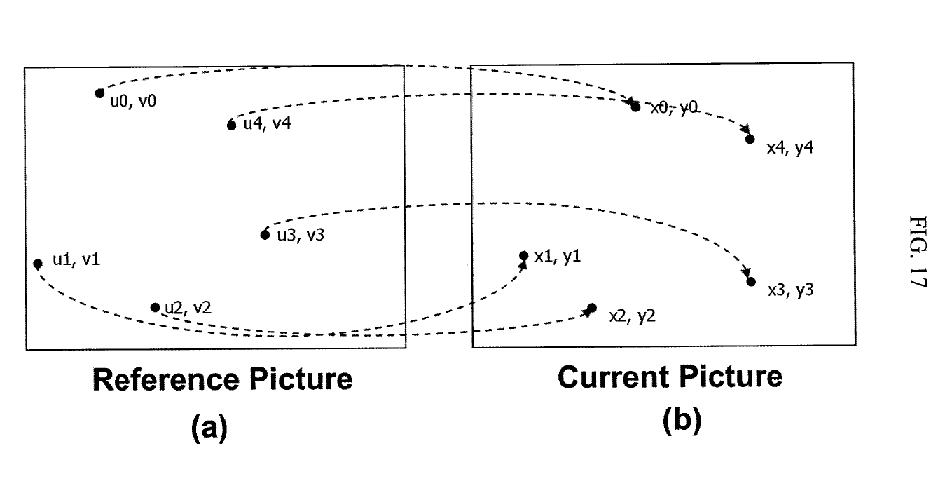

FIG. 17 is a diagram to explain the concept of homography matrix information. The homography matrix information may be a sort of the aforesaid projective transform information.

Referring to FIG. 17, it can be observed that five points [(u₀, v₀), . . . , (u₄, v₄)] in a reference picture (a) correspond to five points [(x₀, y₀), . . . , (x₄, y₄)] in a reference picture (b), respectively. In general, the homography matrix information can be defined as the following formulas.

x′=Hx [Formula 6]

In Formula 6, x′ indicates a point in a world coordinate system, x indicates a point in a local coordinate system of each view, and H indicates a homogeneous matrix.

$$( \begin{matrix}{x}_{1}^{′} \\ {x}_{2}^{′} \\ {x}_{3}^{′}\end{matrix} ) = [ \begin{matrix}{h}_{11} & {h}_{12} & {h}_{13} \\ {h}_{21} & {h}_{22} & {h}_{23} \\ {h}_{31} & {h}_{32} & {h}_{33}\end{matrix} ] ( \begin{matrix}{x}_{1} \\ {x}_{2} \\ {x}_{3}\end{matrix} ) \qquad [ Formula 7 ]$$

If five points are substituted, as shown in FIG. 17, the homography matrix information can be calculated as the following formula. In this case, what kind of physical meaning each point has and how each point is extracted will be explained in the description of a warping information obtaining process later.

$$[ \begin{matrix}x 0 & y 0 & 1 \\ x 1 & y 1 & 1 \\ x 2 & y 2 & 1 \\ x 3 & y 3 & 1 \\ x 4 & y 4 & 1 \\ & ⋮ & \end{matrix} ] = [ \begin{matrix}u 0 & v 0 & 1 \\ u 1 & v 1 & 1 \\ u 2 & v 2 & 1 \\ u 3 & v 3 & 1 \\ u 4 & v 4 & 1 \\ & ⋮ & \end{matrix} ] [ \begin{matrix}{h}_{11} & {h}_{12} & {h}_{13} \\ {h}_{21} & {h}_{22} & {h}_{23} \\ {h}_{31} & {h}_{32} & 1\end{matrix} ] \qquad [ Formula 8 ]$$

(2) Process for Obtaining Warping Information & Warped Reference Picture

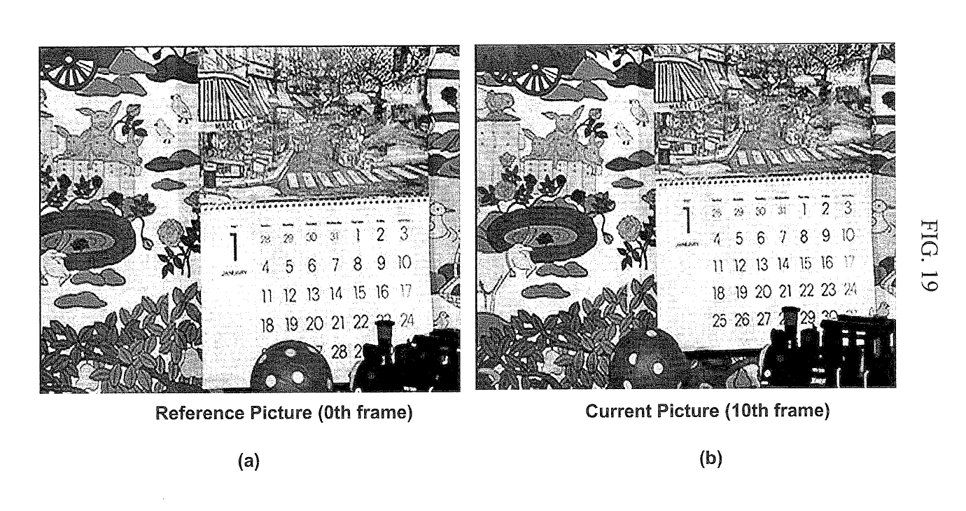

FIG. 18 is a flowchart of a process for obtaining warping information and a warped reference picture. In the following description, in case that warping information is homography matrix information, a process for generating warping-transformed reference picture by obtaining homography matrix information and using the obtained homography matrix information will be explained with reference to FIGS. 19 to 24. FIG. 19 is an exemplary diagram of reference and current pictures. Referring to FIG. 19, it is observed that a wall paper is provided as a background to a reference picture (a). And, it is also observed that a calendar, a ball, a train and the like are provided as objects to the reference picture. Referring to (b) of FIG. 19, in can be observed in a current picture that the calendar is reduced in size to be smaller than that of the reference picture (a). It can be observed that the ball is moved to the right. And, it can be also observed that the train approaches. In the following description, steps S310 to S360 will be explained using the example shown in FIG. 19.

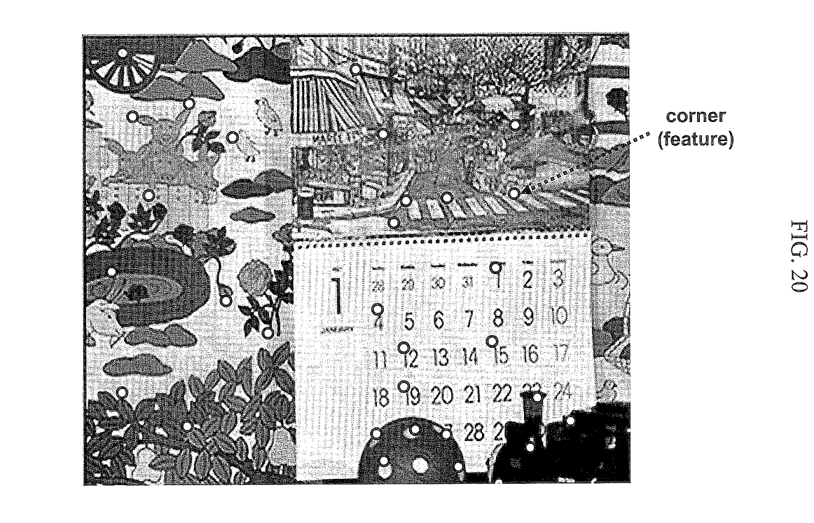

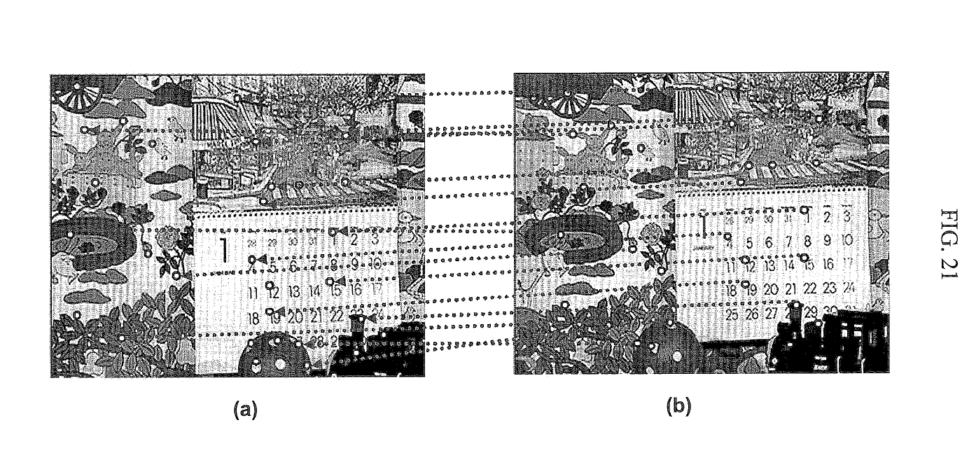

First of all, a corner (feature) is found using a corner detecting method [S310]. FIG. 20 is a diagram to explain the step S310 [corner (feature) finding step] among the steps shown in FIG. 18. Referring to FIG. 20, it can be observed that various corners in a picture are detected. In this case, the corner means a point that is advantageous in being tracked by a next picture. And, the corner detecting method may adopt KLT (Kanade-Lucas_Tomasi feature tracker) scheme, by which the present invention is non-limited. Subsequently, tracking is carried out on the corner detected using a feature tracking algorithm (e.g., KLT scheme) in the step S310 [S320]. FIG. 21 is a diagram to explain the step S320 [corner tracking step] among the steps shown in FIG. 18. Referring to FIG. 21, after a current picture (b) has been searched for corners, it can be tracked where corners corresponding to the former corners in the current picture (b) exist in a reference picture (a).

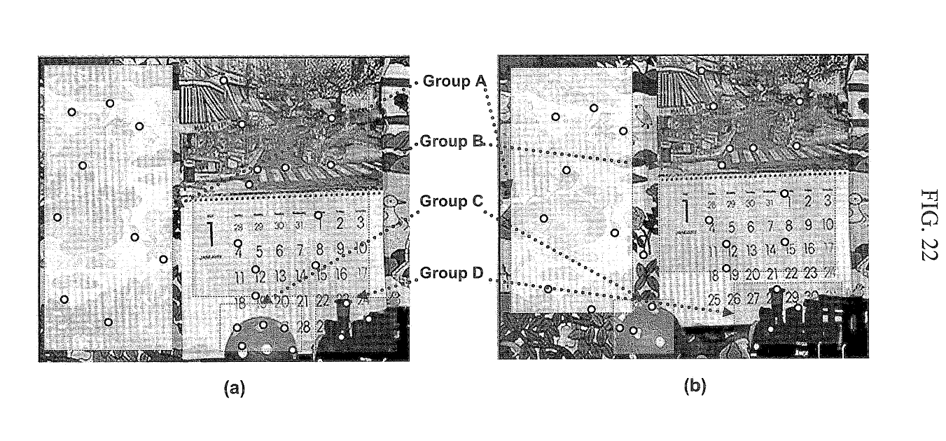

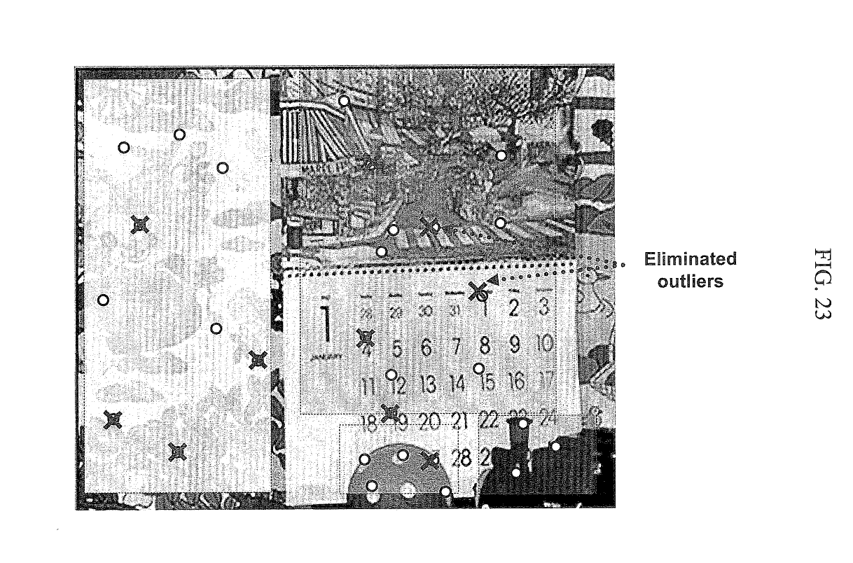

Subsequently, the corners are grouped using motion segmentation [S330]. There can exist various areas having different motion, rotation and zooming features. If the corners are grouped into specific corners having the same features, warping transformation can be efficiently achieved. Through the corner grouping, motion or affine relation of each coder can be taken into consideration. FIG. 22 is a diagram to explain the step S330 [corner grouping step] among the steps shown in FIG. 18. Referring to FIG. 22, it can be observed corners existing on a wall paper are grouped into a group A, corners on a calendar are grouped into a group B, corner on a ball are grouped into a group C, and corners on a train are grouped into a group D. subsequently, corners are eliminated in part from the corners grouped in the step S330 using outlier algorithm or the like. In this case, the outlier means a value considerably smaller or bigger than other values. For instance, ‘25 ’ is an outlier in {3, 5, 4, 4, 6, 2, 25, 5, 6, 2}. Meanwhile, as a method of eliminating the outlier, RANSAC (RANdom Sample Concensus) algorithm is usable. The RANSAC algorithm is the algorithm for eliminating corners except corners most suitable for representing a homography matrix. And, the RANSAC algorithm is able to generate most suitable homography matrix information using most suitable four corresponding pairs. FIG. 23 is a diagram to explain the step S340 [outlier eliminating step] among the steps shown in FIG. 18. Referring to FIG. 23, it can be observed that four corners are eliminated from corners belonging to a group A. And, it can be also observed that four corners are eliminated as outliers from corners belonging to a group B. Thus, it is able to eliminate corners exceeding four of a plurality of corners belonging to a prescribed group. As mentioned in the foregoing description, it may be able to eliminate outliers using RANSAC algorithm. And, it is also able to skip RANSAC algorithm in case that outliers are filtered off in the groping processing.

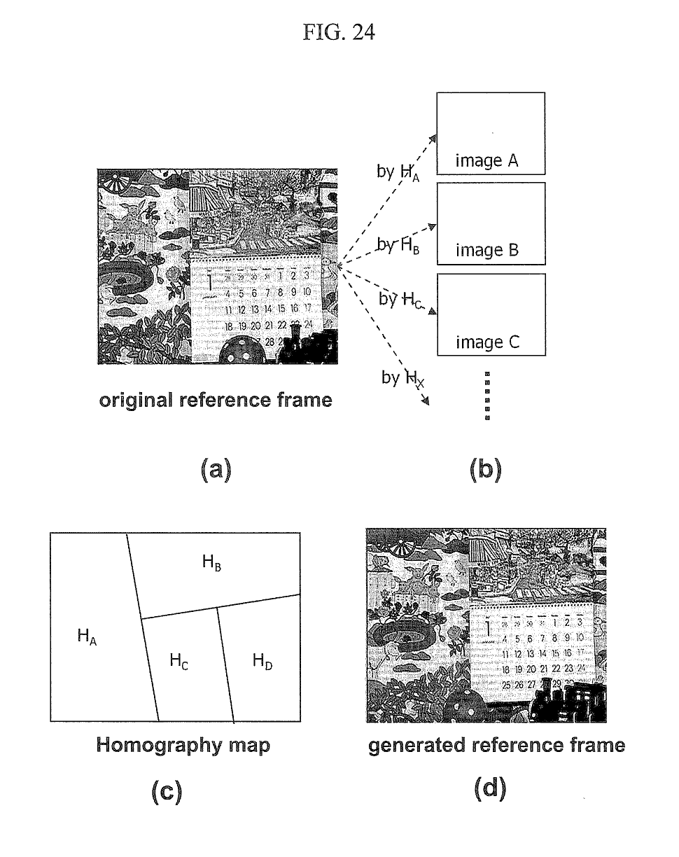

Subsequently, homography matrix information per group is determined using positions of corners remaining among the corners corresponding to each of the groups instead of being eliminated in the step S340 [S350]. The homography matrix information can be calculated in a manner of substituting positions of the corners into the formula defined by Formula 8. The homography matrix information corresponds to relation of features between two pictures. In the homography matrix information, a single point in a first picture corresponds to a single point in a second picture. On the contrary, a single point in the second picture corresponds to a single point in the first picture. Subsequently, a warped reference picture is generated using the homography matrix information obtained in the step S350 [S360]. FIG. 24 is a diagram to explain the step S360 [reference picture generating step] among the steps shown in FIG. 18. Referring to FIG. 24, images resulting from applying per-group homography matrix information H_{A}, H_{B}, H_{C}, H_{D}, . . . to an original reference picture (a) are shown in (b) of FIG. 24. Meanwhile, a homography map is shown in (c) of FIG. 24. To obtain the homography map, it is able to calculate a difference between a random image having the homography matrix information applied thereto and a current picture. The images shown in (b) of FIG. 24 can be cut and attached according to the homography map shown in (c) of FIG. 24. The homography map may be configured by a unit of pixel, block, macroblock or the like. Since information amount of the homography map is inverse proportional to accuracy, the unit of the homography map can be appropriately selected if necessary. Thus, it is able to generate a reference picture shown in (d) of FIG. 24 using the homography map shown in (c) of FIG. 24. Alternatively, it is able to use each of the images shown in (b) of FIG. 24 instead of cutting and attaching the images according to the homography map.

(3) Obtaining Reference Picture Using Warping Information

In the foreign description, the concept of warping, the types of warping information and the process of obtaining warping information are explained in detail. In the following description, a process for deciding whether to apply warping transformation to obtaining a reference picture is explained.

FIG. 25 is a flowchart for a warping application deciding process. Steps S410 to S495 in FIG. 25 can be executed in case that a current picture (or a current slice) is a picture-B (or a slice-B) or a picture-P (or a slice-P). Meanwhile, the steps S410 to S495 can be carried out by the inter-prediction unit 370 or the motion estimation unit 360, by which the present invention is non-limited.

First of all, a warping application variable useWarp, a bit number variable tempOrgCost and a warping bit number variable tempWarpCost are set to 0 [S410]. Subsequently, a reference picture list is constructed [S420]. If the warping application variable useWarp is 0 [‘no’ in the step S430], motion estimation and compensation are carried out on an entire picture [S440]. After a bit number RD COST required for coding of a current picture (or a current slice) has been calculated, the calculated bit number is stored in the bit number variable tempOrgCost. The warping application variable useWarp is set to 1. The routine then goes to a step S430 [S450].

If the warping application variable useWarp is 1 in the step S430 [‘yes’ in the step S430], an original reference picture is stored in a temporary memory and the whole reference picture is warping-transformed using warping information [S460]. In this case, as mentioned in the foregoing description, affine transformation information is generated using six points and all reference pictures can then be affine-transformed using the affine transformation information, by which the present invention is non-limited. Subsequently, after the bit number RD COST required for the coding of the current picture (or the current slice) has been calculated, the calculated bit number is stored in the warping bit number variable tempWarpCost [S470].

If a value stored in the warping bit number variable tempWarpCost in the step S470 is smaller than a value stored in the bit number variable tempOrgCost in the step S450 [‘yes’ in the step S480], warping information is stored and warping application flag information use_warp flag indicating whether warping transformation is used is set to 1 [S490]. Otherwise [‘no’ in the step S480), the warping application flag information use_warp_flag is set to 0 [s495]. Subsequently, the reference picture is reconstructed to the original prior to the warping transformation.

(4) Motion Vector Prediction Using Warping Information

It is able to predict a motion vector using warping information generated by the above-mentioned method. FIG. 26 is a diagram to explain the concept of motion vector prediction. Referring to (a) of FIG. 26, a left block A, an above block C and an above right block C exist by neighboring to a current block. And, it is able to generate a motion vector predictor of a motion vector of the current block using motion vectors of the neighbor blocks. The motion vector predictor of the current block can be a median value of the motion vectors of the neighbor blocks. In this case, the motion vector of the current block absolutely depends on motion information of neighbor blocks. So, referring to (b) of FIG. 26, if the motion vector of the current block is almost similar to the motion vector of each of the neighbor blocks, it is able to obtain a predictor similar to the motion vector of the current block. On the other hand, referring to (c) of FIG. 26, if the motion vector of the current block is not similar to the motion vector of each of the neighbor blocks at all and if it differs in direction as well, it is difficult to obtain an appropriate predictor from the neighbor blocks and the considerably large bit number is required for coding a motion vector difference.

Meanwhile, it is able to predict a motion vector using warping information. In this case, the warping information may include the homography matrix information generated in the step S350 described with reference to FIG. 18.

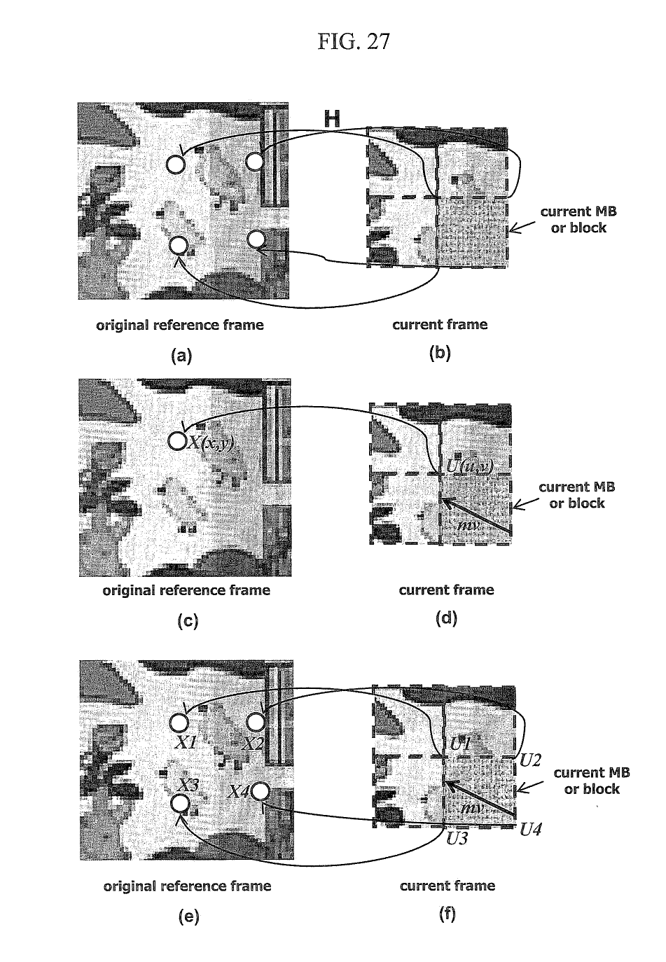

FIG. 27 is a diagram to explain motion vector prediction using warping information.

Referring to FIG. 27, all pixels belonging to a current picture (b) can be mapped to pixels belonging to an original reference picture (a) through homography matrix information H. For instance, an upper left point, an upper right point, a lower left point and a lower right point of a current block are linked to four pixels belonging to the original reference picture (a), respectively.

Hence, as shown in Formula 9, a point (u, v) in the current picture, which is a point in a 2-dimensional plane, can be transformed into a point (x, y) in the original reference picture. This means that 0ne-to-one mapping is possible by a pixel unit.

$$X = HU \\ [ \begin{matrix}x \\ y \\ 1\end{matrix} ] = [ \begin{matrix}{h}_{11} & {h}_{12} & {h}_{13} \\ {h}_{21} & {h}_{22} & {h}_{23} \\ {h}_{31} & {h}_{32} & 1\end{matrix} ] [ \begin{matrix}u \\ v \\ 1\end{matrix} ] \qquad [ Formula 9 ]$$

In Formula 9, hᵢⱼ indicates a homography matrix coefficient, U(u, v) indicates a point in a current picture, and X(x, y) indicates a point in an original reference picture.

Firstly, referring to (c) and (d) of FIG. 27, it can be observed that there exist a position U(u, v) of the upper left point of the current block (d) and a point X(x, y) of the reference picture (c) mapped to the position U(u, v). Using these two points, it is able to predict a motion vector of the current block. In particular, it is able to use a difference between the upper left point X of the current picture and a pixel Y in the original reference picture mapped to the corresponding point as a motion vector predictor (mvp). This can be defined as the following formula.

mvp=X−U [Formula 10]

In formula 10, mvp is a motion vector predictor, X indicates a pel in an original reference picture, and U indicates a pel in a current picture.

Secondly, referring to (e) and (f) of FIG. 27, it can be observed that there exist an upper left point U1, an upper right point U2, a lower left point U3 and a lower right point U4 of a current block (f) and points X1, X2, X3 and X4 in a reference picture (e) which are mapped to the former points, respectively. Using these eight points, it is able to predict a motion vector of the current block. In particular, it is able to obtain a motion vector predictor (mvp) by averaging differences between the points mapped to each other as the following formula.

mvp={(X1−U1)+(X2−U2)+(X3−U3)+(X4−U4)}/4 [Formula 11]

In Formula 11, U1, U2, U3 and U4 indicate points in a current picture and X1, X2, X3 and X4 indicate points in an original reference picture.

Thirdly, it is able to determine a median value of difference values of three pairs among total tour pairs as a motion vector predictor (mvp) as the following formula.

mvp=median{(X1−U1),(X2−U2),(X3−U3)} or median{(X1−U1),(X2−U2),(X4−U4)} or median{(X2−U2),(X3−U3),(X4−U4)} [Formula 12]

In Formula 12, U1, U2, U3 and U4 indicate points in a current picture and X1, X2, X3 and X4 indicate points in an original reference picture.

Fourthly, in case of a warping-transformed reference picture instead of an original reference picture, a homography matrix component was already reflected in a reference picture. So, a difference between points in a current picture and points in a warped reference picture becomes 0. Hence, in case of a warping-transformed reference picture, a motion vector predictor (mvp) becomes as the following formula. In this case, it becomes a motion vector difference (mvd), i.e., a motion vector (mv) of a current block.

mvp=0, mvd=mv [Formula 13]

In Formula 13, mvp indicates a motion vector predictor in case of a warped reference picture.

After the motion vector predictor (mvp) has been obtained by the above-mentioned method, a motion vector difference (mvd) can be respectively defined as the following formula.

[Formula 14]

mvd=mv−mvp=mv−(X−U) (1)

mvd=mv−{(X1−U1)+(X2−U2)+(X3−U3)+(X4−U4)}/4 (2)

mvd=mv−median{(X1−U1),(X2−U2),(X3−U3)} or mv−median{(X1−U1),(X2−U2),(X4−U4)} or mv−median{(X2−U2),(X3−U3),(X4−U4)} (3)

mvd=mv (4) (in case of warped reference picture)

There can exist a motion vector difference calculated using warping information according to Formula 14 and a motion vector difference calculated using motion vectors of neighbor blocks as described with reference to FIG. 26. After these two differences have been compared to each other, it is able to determine a scheme for consuming the smaller number of bits as a block unit. And, prediction scheme flag information (use_warp_mvp_flag) indicating how the prediction is made can be set by a bock unit as the following table.

TABLE 3
Prediction scheme flag information

| use_warp_mvp_flag | Meaning |
|---|---|
| 0 | Motion vector of current block is |
| | predicted using motion vectors of |
| | neighbor blocks |
| 1 | Motion vector of current block is |
| | predicted using warping |
| | information |

Meanwhile, in case of using warping information, 1) whether an upper left point is used, 2) whether an average value of four points is used, and 3) whether a median value of four points is used can be set in detail as the following table.

TABLE 4
Prediction scheme flag information

| use_warp_mvp_flag | Meaning |
|---|---|
| 0 | Motion vector of current block is |
| | predicted using motion vectors of |
| | neighbor blocks |
| 1 | Motion vector of current block is |
| | predicted using warping information |
| | (use an upper left point) |
| 2 | Motion vector of current block is |
| | predicted using warping information |
| | (use an average of four points) |
| 3 | Motion vector of current block is |
| | predicted using warping information |
| | (use a median value of four points) |

As mentioned in the above description, the encoder obtains warping information using a current picture and a reference picture, decides whether to perform warping transformation by applying warping information to a reference picture or whether to predict a motion vector using warping information, and the like, and is then able to transport the corresponding information via a bitstream.

2.2 Transport of Warping Information

(1) Syntax of Warping Information

In the following description, a method of transporting warping information, warping application flag information (use_warp_flag) and the like via a bitstream is explained.

First of all, it is able to transport warping sequence flag information (use_warp_seq_flag), which is the information indicating whether at least one slice having warping information exist therein exists in a current slice, via a sequence parameter set (seq_parameter_set_rbsp) as the following table.

TABLE 5
Example for method of transporting warping
sequence flag information

| | |
|---|---|
| seq_parameter_set_rbsp( ) { | |
| Profile_idc | |
| constraint_set0_flag | |
| constraint_set1_flag | |
| ... | |
| use_warp_seq_flag | (A) |
| ... | |

The meaning of the warping sequence flag information can be defined as the following table. Namely, if warping sequence flag information is 0, it is not necessary to extract warping application flag information (use_warp_flag) indicating whether warping information exists in each slice.

TABLE 6
Meaning of warping sequence flag
information

| use_warp_seq_flag | Meaning |
|---|---|
| 0 | Warping information does not exist in |
| | current sequence. |
| 1 | At least one slice (or block) having warping |
| | information exist therein exists in a |
| | current sequence. |

Meanwhile, an example for a method of transporting warping application flag information (use_warp_flag) and warping information (warping_parameter_amn_{—}10[i]) in a slice layer is shown in the following table.

TABLE 7
Example for a method of transporting
warping application flag information and warping
information

| | |
|---|---|
| slice_header( ) { | |
| first_mb_in_slice | |
| slice_type | |
| Pic_parameter_set_id | |
| frame_num | |
| ... | |
| if( use_warp_seq_flag && (slice_type == B \|\| | |
| slice_type == P)) | |
| use_warp_flag | (B) |
| if( use_warp_flag && (slice_type == B \|\| | |
| slice_type == P)) { | |
| for (i=0; i<num_ref_idx_l0_active_minus1+1; i++) { | |
| warping_parameter_a11_l0[i] | (C₁) |
| warping_parameter_a12_l0[i] | |
| ... | |
| warping_parameter_amn_l0[i] } | (Cₖ) |
| if (slice_type == B) { | |
| for (i=0; i<num_ref_idx_l1_active_minus1+1; i++) { | |
| warping_parameters_a11_l1[i] | (D₁) |
| warping_parameters_a12_l1[i] | |
| .... | |
| warping_parameters_amn_l1[i] } | (Cₖ) |
| }} | |

In Table 7, looking into a row indicated by (B) in a right column, it can be observed that warping application flag information (use_warp_flag) is included only if warping sequence flag information (use_warp_seq_flag) is 1 and if a current slice is a slice-B or a slice-P. And, the meaning of the warping application flag information is shown in the following table.

TABLE 8
Meaning of warping application flag
information

| use_warp_flag | Meaning |
|---|---|
| 0 | Warping information does not exist in a |
| | current slice (current block). |
| 1 | Warping information exists in a current |
| | slice (current block). |

Meanwhile, referring to rows indicated by (c₁) to (Cₖ) in the right column of Table 7, it can be observed that warping information (warping_parameter_amn_{—}10[i]) is included only if warping application flag information (use_warp_flag) is 1. The number (k) of warping information may correspond to 6 if warping information is affine transformation information. The number (k) of warping information may correspond to 8 if warping information is homography matrix information. Moreover, the present invention can be implemented in various ways.

(2) Method of Saving the Bit Number of Warping Information

Warping information may correspond to homography matrix information. And, an example of the homography matrix information is represented as Formula 15.

$$\begin{matrix}H = [ \begin{matrix}a 11 & a 12 & a 13 \\ a 21 & a 22 & a 23 \\ a 31 & a 32 & 1\end{matrix} ] \\ = [ \begin{matrix}- 0.21151279502168274000 & - 0.57177497055892856000 & 180.09247607819327000000 \\ - 0.31552273967810845000 & - 0.67001180746977662000 & 224.23647899774312000000 \\ - 0.00135033692472275340 & - 0.00304247061888797150 & 1.00000000000000000000\end{matrix} ]\end{matrix} \qquad [ Formula 15 ]$$

Referring to Formula 15, it can be observed that a component of a third column in a first row is greater than 180 while a component of a first or second column in the first row is smaller than 1. So, a considerably large number of bits are required for transporting the respective coefficients of warping information. If the coefficients are quantized in order to reduce the bit number, accuracy of warping information may be considerably reduced. Hence, a method of raising coding efficiency by keeping accuracy is needed.

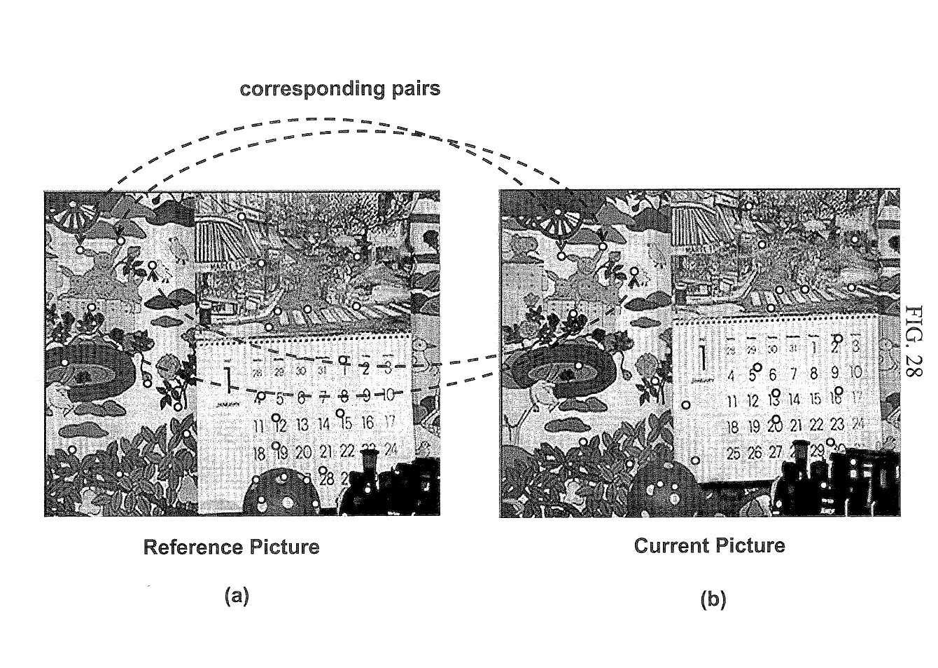

Firstly, it is able to code position information of corresponding pairs instead of coding coefficients of a homography matrix. FIG. 28 is a diagram to explain a first method for raising coding efficiency of warping information. Referring to FIG. 28, corresponding pairs required for generating homography matrix information are represented. The corresponding pairs may have the same concept of the corresponding points described with reference to FIG. 21. Thus, an encoder is capable of transporting position information of the corresponding pairs instead of transporting homography matrix information. In the corresponding pairs, a position of a point in a current picture has an integer number unit and a position of a point in a reference picture has a decimal unit. So, it may become a value much simpler than the homography matrix coefficient. Thus, in case of transporting position information of the corresponding pairs, it is able to considerably raise coding efficiency without degrading matrix accuracy.

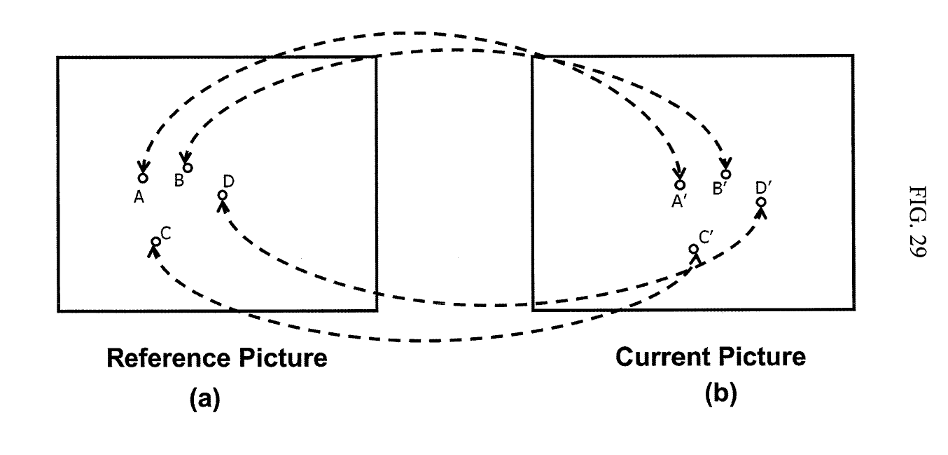

Secondly, in transporting position information of corresponding pairs, it is able to transport a difference value instead of transporting the position information as it is. FIG. 29 is a diagram to explain a second method for raising coding efficiency of warping information. Referring to FIG. 29, it can be observed that A, B, C and D exist in a reference picture (a). And, it is also observed that A′, B′, C′ and D′ exist in a current picture (b). In this case, A and A′ configure a corresponding pair and B and B′ configure another corresponding pair as well. Generally, since position information of each of the corresponding pairs has a similar value, coding efficiency can be raised by coding (A, A-A′), (A, A′-A) or the like instead of coding (A, A′). In this case, a decoder is able to obtain (A, A′) by receiving (A, A-A′).

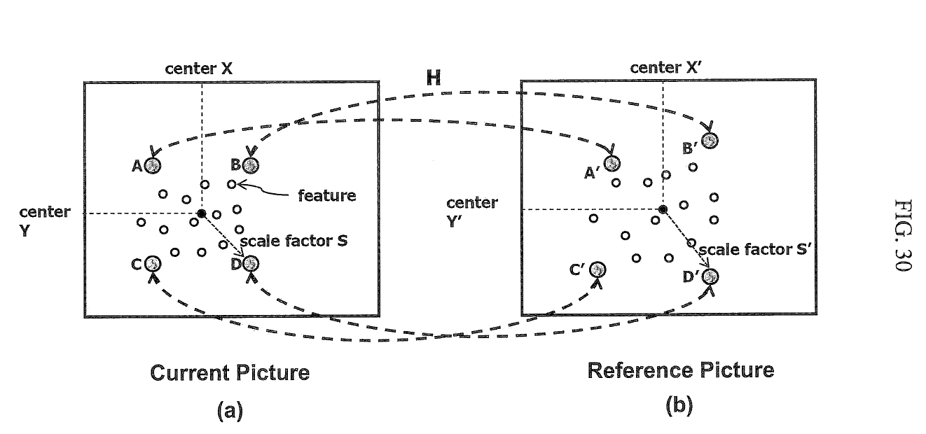

Thirdly, it is able to transport a value resulting from normalizing position information of a corresponding pair. FIG. 30 is a diagram to explain a third method for raising coding efficiency of warping information. Referring to FIG. 30, corners including A, B, C and D exist in a current picture (a), while corresponding corners including A′, B′, C′ and D′ exist in a reference picture (b). These corners may be grouped by motion segmentation. Meanwhile, it is able to calculate a center position (X, Y) of corners belonging to a prescribed group in the current picture (a). In this case, position of the corners can be equalized to an average value. In order to consider a distance between the center (X, Y) and each of the corners A, B, C and D, it is able to calculate a scale factor S. In this manner, it is able to calculate a center (X′, Y′) and a scale factor S′ in the reference picture (b).

It is able to set positions of four points A, B, C and D to (X−k, Y−k), (X+k, Y−k), (X−k, Y+k) and (X+k, Y+k), respectively. In this case, k is a small integer number. And, it is able to calculate warped positions A′, B′, C′ and D′ using the previously generated homography matrix information (H). Subsequently, the scale factors S and S′, the center positions (X, Y) and (X′, Y′) and four feature positions A′, B′, C′ and D′ are transported. Meanwhile, to further reduce the bit number, the four feature positions A′, B′, C′ and D′ can be replaced by A-A′, B-B′, C-C′ and D-D′.

Even if normalization is performed using the scale factors and the center positions, it may be inefficient for the bit number. If so, it may be advantageous for saving the bit number by not applying the above normalization method and by not transporting the scale factors and the center positions.

(3) Warping Skip Mode Using Warping Information

If a current block refers to a warped reference picture and if neighbor blocks of the current block refer to an original reference picture that is not warped, a motion vector predictor of the current block, which is predicted from motion vectors of the neighbor blocks, may be reduced in similarity.

Meanwhile, as mentioned in the foregoing description with reference to Formula 13, in case that a current block refers to a warped reference picture, a motion vector predictor (mvp) using warping information becomes 0 and a difference value (mvd) from a motion vector of the current block may becomes almost 0. If so, since the motion vector difference (mvd) may approach 0, it is able to skip the transport of the motion vector difference (mvd). Moreover, in this case, since similarity between the current picture and the warped reference picture can be possibly very high, a residual corresponding to a difference between the current picture and the warped reference picture may not be transported as well. Thus, in case of skipping the transports of the motion vector difference and the residual, warping skip mode flag information (warp_skip_flag) indicating the fact of the skipping can be set to 1. Syntax about the warping skip mode is shown in the following table.

TABLE 9
Syntax of warping skip mode

| | |
|---|---|
| macroblock_layer( ) { | |
| warping_skip_flag | (E) |
| if( !warping_skip_flag) { | (F1) |
| mb_type | (F2) |
| if( mb_type == l_PCM ) { | |
| while( !byte_aligned( ) ) | |
| pcm_alignment_zero_bit | |
| for( i = 0; i < 256; i++ ) | |
| pcm_sample_luma[ i ] | (G1) |
| for( i = 0; i < 2 * MbWidthC * MbHeightC; i++ ){ | |
| pcm_sample_chroma[ i ] | (G2) |

In Table 9, looking into a row indicated by (E) in a right column, it can be observed that warping skip mode flag information (warping_skip_flag) is included. The meaning of this flag information can be defined as follows.

TABLE 10
Meaning of warping skip mode flag
information

| warping_skip_flag | Meaning |
|---|---|
| 0 | Motion information and residual of |
| | current block are transported. |
| 1 | Transport of motion information and |
| | residual of current block are skipped. |

In Table 9, looking into a row indicated by (E) in a right column, it can be observed that motion information and residual information are included only if warping skip mode flag information is 0. Meanwhile, if the warping skip mode flag information is 1, when a slice-P or a slice-SP is decoded, a macroblock type of a current block becomes P_Warping_Skip and the macroblock type is referred to as a macroblock-P overall. In case of decoding a slice-B, a macroblock type becomes B_Warping_Skip and the macroblock type is referred to as a macroblock-B overall.

In case of warping skip mode, a process executed in decoding shall be explained in the description of ‘2.3 Use of Warping Information’.

2.3 Use of Warping Information (in Decoder)

(1) Reference Picture Obtainment Using Warping Information

Decoder is able to warping-transform a reference picture using transported warping information. In particular, in case that warping information exists in a current slice (or a current block) (e.g., in case that warping application flag information (use_warp_flag) is 1), warping information of the current slice (or the current block) is extracted. If so, it is able to warp-transform a reference picture using the extracted warping information. For instance, in case of receiving homography matrix information (H) represented as Formula 8, each pixel (x) of the reference picture can be transformed into each pixel (x′) of the warped reference picture using the received homography matrix information (H). Thus, the warped reference picture becomes the former picture shown in (d) of FIG. 24. And, the warped reference picture can be referred to in order to generate a predictor of a current picture (or a current block).

FIG. 31 is a diagram for a reference relation of a current picture.

Referring to FIG. 31, in case of a first case (Case 1), it can be observed that a current frame (or picture) (a) refers to not an original reference picture (a) but a warped reference picture (b) only. In this case, since the original reference picture (a) is replaced by the warped reference picture (b), a size of picture to be stored in a decoded picture buffer is not increased. Meanwhile, in case of a second case (Case 2), it can be observed that both a warped reference picture (b) and an original reference picture (a) are simultaneously referred to. In this case, since the warped reference picture (b) is added to a previous reference picture list, it is advantageous in that additional information not included in the previous reference picture is provided.

(2) Motion Vector Prediction Using Warping Information

If a motion vector is predicted using warping information, (e.g., as mentioned in the foregoing description with reference to FIG. 27, if prediction scheme flag information (use_warp_mvp_flag) is not 0), a decoder finds that a specific point (U) in a current picture corresponds to a prescribed point (X) in a reference picture. Subsequently, the decoder obtains a motion vector predictor (mvp) of a current block using both of the points X and U. The decoder then obtains a motion vector (mv) of the current block by adding a motion vector difference (mvd) received via bitstream to the motion vector predictor (mvp).

(3) Warping Skip Mode Using Warping Information

As mentioned in the foregoing description, in case that a current block corresponds to a warping skip mode (e.g., if warping skip mode flag information (warping_skip_flag) is 1), motion information and residual of the current block are not transported. In this case, a decoder uses a warped reference picture as a reference picture, performs motion compensation by setting a motion vector to a zero vector, and sets a residual to 0.

3. 8^{th} pel Motion Compensation

In a motion estimating process for searching a reference picture for an area most similar to a current block of a current picture, it is able to obtain more accurate result by performing motion estimation at an interpolated sample position of the reference picture. For instance, in case that interpolation is carried out to a position of ½ sample (half sample), it is able to find an area more matching a current block by searching interpolated pixels. Moreover, in case of ¼ pixel (quarter pixel) motion estimation, in order to find a most matching position, motion estimation is carried out on an integer sample position in a first step. An encoder checks whether to obtain a better result by searching ½ sample position centering on the most matching position found by the first step. If necessary, the encoder searches for ¼ sample position centering on the most matching ½ sample position. The encoder performs a subtraction operation on values of finally matching positions (integer, ½ or ¼ position) from a current block or a current macroblock.

In case of using ¼ sample interpolation, error energy is smaller than that of the case of using ½ sample interpolation. Finer interpolation may provide better performance in motion compensation in general but complexity increases as well. And, a benefit of performance tends to decrease in proportion to interpolation steps.

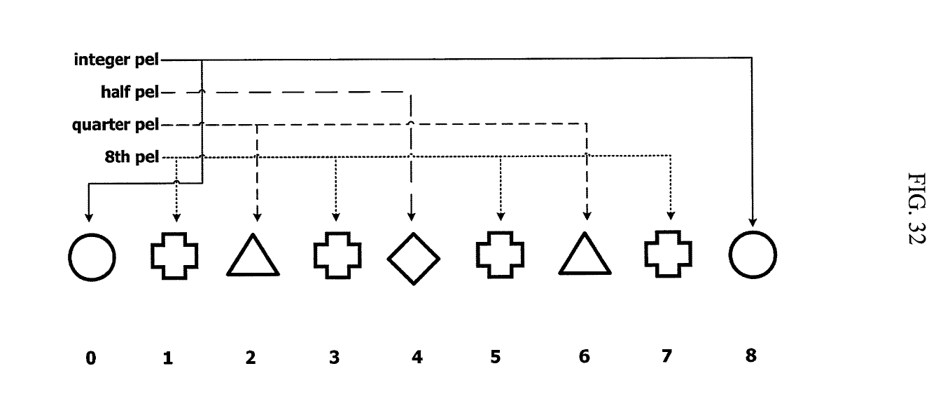

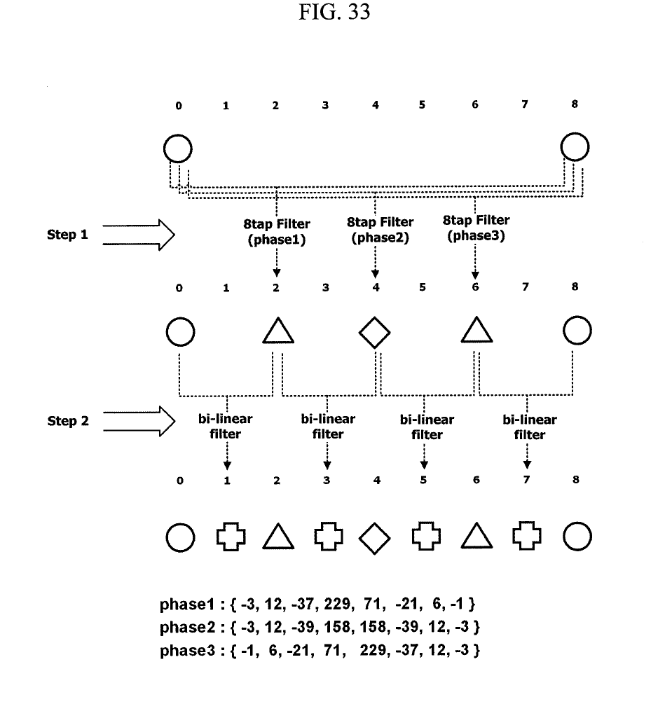

FIG. 32 is a diagram to explain the concept of ⅛ pel. Referring to FIG. 32, it can be observed that pels are 1-dimensionally arranged at positions 0 to 8, respectively. Integer pels (circles) are located at the positions 0 and 8, ½ pel (lozenge) is located at the position 4, ¼ pels (triangles) are located at the positions 2 and 6, and ⅛ pels (crosses) are located at the positions 1, 3, 5 and 7, respectively. FIG. 33 is a diagram to explain an interpolation step of ⅛ pel motion compensation method. Referring to FIG. 33, in a first step (Step 1), ½ pel at a position 4 and ¼ pels at positions 2 and 6 are generated via 8-tap filters using integer pels. Subsequently, in a second step (Step 2), it can be observed that ⅛ pels are generated via bi-linear filters using the ½ pel and the ¼ pels obtained in the first step. Namely, since ⅛ pel is generated through at least two steps in ⅛ pel motion compensation, it causes a problem that complexity is considerably raised. So, in the ⅛ pel motion compensation, it is necessary to lower complexity by simplification.

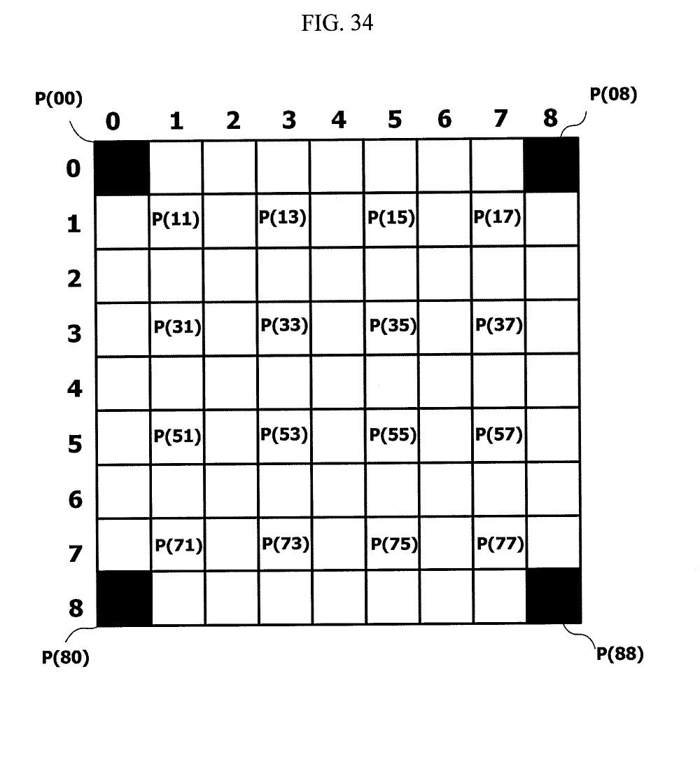

FIG. 34 is a diagram to explain positions of integer, ½ pel, ¼ pel and ⅛ pel in 2-dimension. Referring to FIG. 34, it can be observed that integer pels exist at positions of p(00), p(08), p(80) and p(88). And, it can be also observed that ½ or ¼ pel exists at p(mn) (where m and n are even). Moreover, it can be also observed that a position of ⅛ pel is located at p(mn) (where m and n is odd). Thus, in order to generate ⅛ pel, it may be able to use ½ or ¼ pel. And, it is also able to use integer pels p(00), p(08), p(80) and p(88) only. An example for generating ⅛ pels using integer pels only is represented as Formula 16.

[Formula 16]

p(11)=(A*p(00)+B*p(08)+C*p(80)+4)>>3 (1)

p(17)=(A*p(08)+B*p(00)+C*p(88)+4)>>3 (2)

p(77)=(A*p(88)+B*p(08)+C*p(80)+4)>>3 (3)

p(71)=(A*p(80)+B*p(00)+C*p(88)+4)>>3 (4)

p(33)=(D*p(00)+E*p(08)+F*p(80)+2)>>2 (5)

p(55)=(D*p(88)+E*p(08)+F*p(80)+2)>>2 (6) (7)

p(53)=(D*p(80)+E*p(00)+F*p(88)+2)>>2 (8)

p(13)=(G*p(00)+H*p(08)+I*p(80)+4)>>3 (9)

p(15)=(G*p(08)+H*p(00)+I*p(88)+4)>>3 (10)

p(37)=(G*p(08)+H*p(88)+I*p(00)+4)>>3 (12)

p(75)=(G*p(88)+H*p(80)+I*p(08)+4)>>3 (13)

p(73)=(G*p(80)+H*p(88)+I*p(00)+4)>>3 (14)

p(51)=(G*p(80)+H*p(00)+I*p(88)+4)>>3 (15)

p(31)=(G*p(00)+H*p(80)+I*p(08)+4)>>3 (16)

In Formula 16, (X+4)>>3 is X/8, and (X+2)>>2 is X/4.

Assume that the expressions (1) to (4) belong to a first group. Assume that the expressions (5) to (8) belong to a second group. Assume that the expressions (9) to (16) belong to a third group. If so, coefficients (e.g., A, B, C) used for the expressions belonging to each of the groups are homogenous.

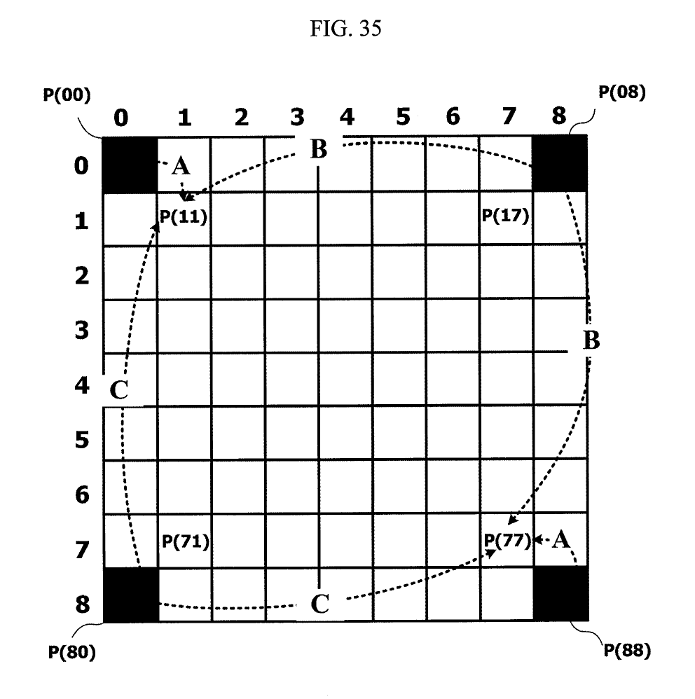

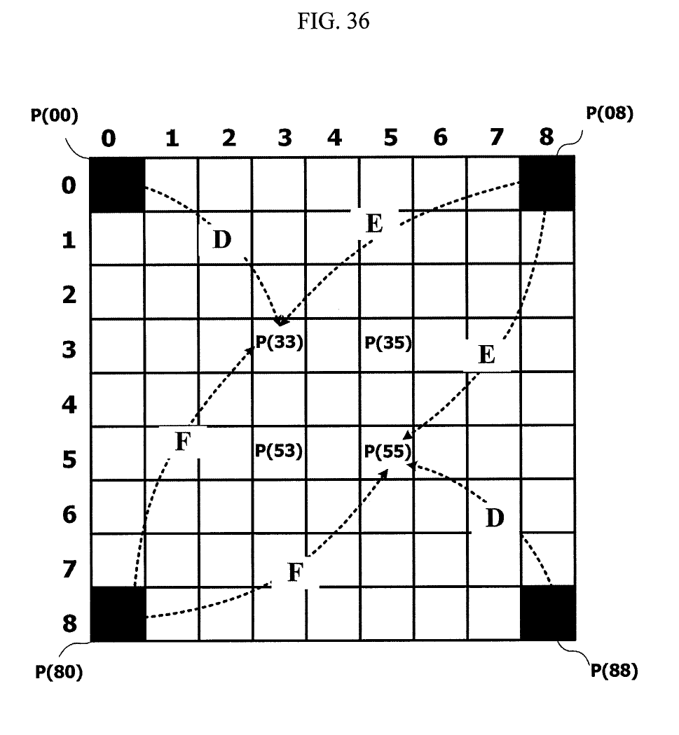

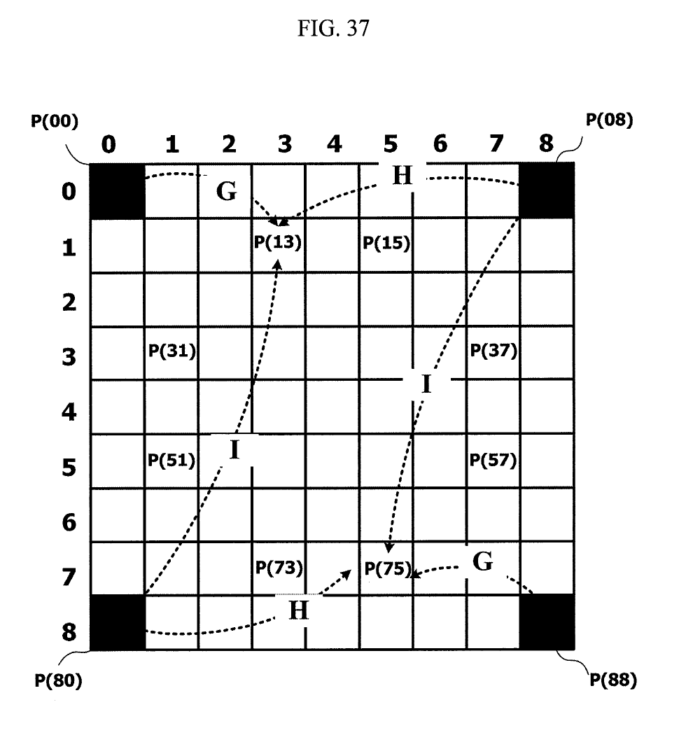

FIG. 35 is a diagram to explain a compensation method of pels corresponding to a first group in ⅛ pel motion compensation method according to an embodiment of the present invention, FIG. 36 is a diagram to explain a compensation method of pels corresponding to a second group in ⅛ pel motion compensation method according to an embodiment of the present invention, and FIG. 37 is a diagram to explain a compensation method of pels corresponding to a third group in ⅛ pel motion compensation method according to an embodiment of the present invention. Referring to FIG. 35, pels p(11), p(17), p(71) and p(77) of a first group have relative positions similar to integer pels p(00), p(08), p(80) and p(88), respectively. As shown in the expression (1) of Formula 16, it can be observed that a coefficient A is applied to the pel p(00) closest to the pel(11). And, it can be also observed that a coefficient B and a coefficient C are applied to the pels p(08) p(80) relatively distant, respectively. In this case, since the relative positions of the pels p(08) and p(80) are similar to each other, the coefficient B and the coefficient C can be equal to each other. Like the case of the pel (11), it can be observed that the coefficient A is applied to the integer pel p(88) closest to the pel p(77). And, it can be also observed that the coefficients B and C are applied to the rest of the integer pels.

Referring to FIG. 36, pels p(33), p(35), p(53) and p(55) belonging to a second group are shown. Looking into the case of the pels p(33) and p(55), it can be observed that a coefficient D is applied to an integer pel p(00) closest to the pel p(33). It can be observed that the coefficient D is applied to the integer pel p(88) closest to the pel p(55). And, it can be also observed that coefficients F and E are applied to the rest of the integer pels, respectively. In this case, the coefficients F and E can be equal to each other as well.

Referring to FIG. 37, eight pels p(13), p(15), p(37), p(57), p(75), p(73), p(51) and p(31) are shown. Looking into the case of the pel p(13), it can be observed that a coefficient G is applied to the closest integer pel p(00). It can be observed that a coefficient H is applied to the second closest integer pel p(08). And, it can be also observed that a coefficient I is applied to a farthest integer pel p(80). This is applicable to the rest of the pels including p(75) in the third group.

An example for applying a specific value to Formula 16 is represented as Formula 17.

[Formula 17]

p(11)=(6*p(00)+p(08)+p(80)+4)>>3 (1)

p(17)=(6*p(08)+p(00)+p(88)+4)>>3 (2)

p(77)=(6*p(88)+p(00)+p(88)+4)>>3 (3)

p(71)=(6*p(80)+p(00)+p(88)+4)>>3 (4)

p(33)=(2*p(00)+p(08)+p(80)+2)>>2 (5)

p(55)=(2*p(88)+p(08)+p(80)+2)>>2 (6)

p(35)=(2*p(08)+p(00)+p(88)+2)>>2 (7)

p(53)=(4*p(80)+3*p(00)+p(88)+4)>>2 (8)

p(13)=(4*p(00)+3*p(08)+p(80)+4)>>3 (9)

p(15)=(4*p(08)+3*p(00)+p(88)+4)>>3 (10)

p(37)=(4*p(08)+3*p(88)+p(00)+4)>>3

p(57)=(4*p(88)+3*p(08)+p(80)+4)>>3 (12)

p(75)=(4*p(88)+3*p(80)+p(08)+4)>>3 (13)

p(73)=(4*p(80)+3*p(88)+p(00)+4)>>3 (14)

p(51)=(4*p(80)+3*p(00)+p(88)+4)>>3 (15)

p(31)=(4*p(00)+3*p(80)+p(08)+4)>>3 (16)

In Formula 17, the case of the first group in Formula 16 (expressions (1) to (4)) corresponds to A=6 and B=C=1, the case of the second group in Formula 16 (expressions (5) to (8)) corresponds to D=2 and E=F=1, and the case of the third group in Formula 16 (expressions (9) to (16)) corresponds to G=4, H=3 and I=1. Thus, each of the coefficients can be determined in proportion to a positional distance between a current pel and each integer pel. In particular, the case of the first group can be defined in proportion to a distance from an integer pel as Formula 18.

A>B=C

D>E=F

G>H>I [Formula 18]

Thus, in case of generating ⅛ pels using integer pels instead of using ½ or ¼ pel, it is able to directly generate them without undergoing several steps. Hence, complexity can be considerably reduced.

Moreover, the encoding/decoding method of the present invention can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet). And, a bit stream produced by the encoding method is stored in a computer-readable recording medium or can be transmitted via wire/wireless communication network.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, the present invention is applicable to encoding/decoding a video signal.

What is claimed is:

1. A method of processing a video signal, comprising:
extracting an overlapping window coefficient from a video signal bitstream;
applying a window to at least one reference area within a reference picture using the overlapping window coefficient;
obtaining a reference block by overlapping the window applied at least one reference area multiply; and,
obtaining a predictor of a current block using the reference block.

2. The method of claim 1, wherein the overlapping window coefficient varies per one of a sequence, a frame, a slice and a block.

3. The method of claim 1, wherein the reference block corresponds to a common area in the overlapped reference areas.

4. A method of processing a video signal, comprising:
obtaining a motion vector by performing motion estimation on a current block;
finding a reference area using the motion vector;
obtaining an overlapping window coefficient minimizing a prediction error by applying at least one window to the reference area to overlap with; and
encoding the overlapping window coefficient.

5. The method of claim 4, wherein in the encoding, the overlapping window coefficient is included in one of a sequence header, a slice header and a macroblock layer.

6. A method of processing a video signal, comprising:
extracting OBMC (overlapped block motion compensation) application flag information from a video signal bitstream;
obtaining a reference block of a current block according to the OBMC application flag information; and,
obtaining a predictor of the current block using the reference block.

7. The method of claim 6, wherein the reference block obtaining is carried out using motion information of the current block.

8. The method of claim 6, wherein in the reference block obtaining, if the OBMC application flag information means that OBMC scheme is applied to the current block or a current slice, the reference block is obtained according to the OBMC scheme.

9. A method of processing a video signal, comprising:
obtaining a motion vector by performing motion estimation on a current block;
calculating a first bit size according to a first motion compensation and a second bit size according to a second motion compensation for a reference area using the motion vector; and
encoding one of information indicating the first motion compensation and information indicating the second motion compensation based on the first bit size and the second bit size.

10. The method of claim 9, wherein the first motion compensation corresponds to a block based motion compensation and wherein the second motion compensation corresponds to an overlapped block based motion compensation.

11. A method of processing a video signal, comprising:
extracting warping information and motion information from a video signal bitstream;
transforming a reference picture using the warping information; and
obtaining a predictor of a current block using the transformed reference picture and the motion information.

12. The method of claim 11, wherein the warping information includes at least one of affine transformation information and projective matrix information.

13. The method of claim 12, wherein the warping information includes position information of corresponding pairs existing in a current picture and the reference picture.

14. The method of claim 13, wherein the position information of the corresponding pairs comprises the position information of a first point, and a difference value between the position information of the first point and the position information of a second point.

15. A method of processing a video signal, comprising:
generating warping information using a current picture and a reference picture;
transforming the reference picture using the warping information;
obtaining a motion vector of a current block using the transformed reference picture; and
encoding the warping information and the motion vector.

16. A method of processing a video signal, comprising:
generating warping information using a current picture and a reference picture;
transforming the reference picture using the warping information;
calculating a first bit number consumed for encoding of a current block using the transformed reference picture;
calculating a second bit number consumed for the encoding of the current block using the reference picture; and
encoding warping application flag information based on the first bit number and the second bit number.

17. The method of claim 16, further comprising deciding whether to transport the warping information according to the first bit number and the second bit number.

18. A method of processing a video signal, comprising:
extracting warping information and prediction scheme flag information from a video signal bitstream;
obtaining a second point within a reference picture, to which at least one first point within a current picture is mapped, using the warping information according to the prediction scheme flag information; and
predicting a motion vector of a current block using a motion vector corresponding to the second point.

19. The method of claim 18, wherein the first point is determined according to the prediction scheme flag information.

20. The method of claim 18, wherein the first point includes at least one of an upper left point, an upper right point, a lower left point and a lower right point.

21. The method of claim 18, wherein if there are at least two first points, the predicting the motion vector of the current block is performed by calculating an average value or a median value of the at least two point.

22. A method of processing a video signal, comprising:
obtaining warping information using a current picture and a reference picture;
obtaining a second point within the reference picture, to which at least one first point within the current picture is mapped, using the warping information; and
encoding prediction scheme flag information based on a motion vector corresponding to the second point and a motion vector of a current block.

23. A method of processing a video signal, comprising:
extracting warping information and warping skip mode flag information from a video signal bitstream;
warping-transform a reference picture using the warping information according to the warping skip mode flag information; and
obtaining a current block using a reference block co-located with a current block within the warping-transformed reference picture.

24. A method of processing a video signal, comprising:
obtaining warping information using a current picture and a reference picture;
warping-transform the reference picture using the warping information;
obtaining a motion vector of a current block using the warping-transformed reference picture; and
encoding warping skip flag information based on the motion vector.

25. A method of processing a video signal, comprising:
searching for a position of a current ⅛ pel with reference to an integer pel;
obtaining a coefficient using the position of the current ⅛ pel; and
generating the current ⅛ pel using the coefficient and the integer pel.

26. The method of claim 25, wherein the integer pel includes three integer pels closer from the current ⅛ pel and wherein the coefficient includes a first coefficient applied to a first integer pel, a second coefficient applied to a second integer pel, and a third coefficient applied to a third integer pel.

27. The method of claim 26, wherein relative values between the first to third coefficients are determined according to relative positions between the first to third integer pels, respectively.

28. The method of claim 26, wherein relative values between the first to third coefficients are determined according to a distance between the current ⅛ pel and the first integer pel, a distance between the current ⅛ pel and the second integer pel, and a distance between the current ⅛ pel and the third integer pel, respectively.

29. The method of claim 25, wherein the video signal is received via broadcast signal.

30. The method of claim 25, wherein the video signal is received via a digital medium.

31. A computer-readable recording medium comprising a program for executing the method of claim 25.
